(19) United States
(12) Patent Application Publication
(10) Pub. No.: US 2026/0257441 A1
(43) Pub. Date: Sep. 3, 2026

(54) PNEUMATIC TIRE, TIRE PROCESSING MACHINE, WHEEL, METHOD, CONTROL DEVICE, AND COMPUTER PROGRAM PRODUCT

(71) Applicant: 4JET MICROTECH GMBH, Alsdorf (DE)

(72) Inventors: Armin KRAUS, Aldenhoven (DE); Jan FLOHRE, Aachen (DE); Robert HILLMANN, Aachen (DE); Volker PETERS, Würselen (DE); Jonas HAWELKA, Aachen (DE)

(21) Appl. No.: 19/167,118

(22) PCT Filed: Mar. 18, 2024
(86) PCT No.: PCT/EP2024/057199

§ 371 Date: Sep. 19, 2025

(30) Foreign Application Priority Data
Mar. 19, 2023 (DE) 20 2023 101 364.3

(51) Int. Cl. B29D 30/48; B60C 15/024

(52) U.S. Cl. CPC B29D 30/48; B60C 15/024

(57) ABSTRACT

Disclosed is a pneumatic tire having a bead having a bead base facing the rotational axis of the pneumatic tire; wherein the bead base has a protrusion extending toward the rotational axis and in a circumferential direction of the bead base; and wherein the protrusion has a geometry varying in the circumferential direction. Further disclosed is a pneumatic tire having a bead having a bead base facing a rotational axis of the pneumatic tire; wherein the bead base comprises a surface structure generated by removal of tire material along processing tracks in a processing region of the bead base; and wherein the surface structure is undulated. Further disclosed is a method and a tire processing machine for manufacturing the pneumatic tire. Further disclosed is a method for operating a tire processing machine, a wheel comprising the pneumatic tire, and a control device for controlling a method and a computer program product for controlling the method.

### CROSS-REFERENCE TO RELATED APPLICATIONS

This Application is a National Phase Patent Application and claims priority to and the benefit of International Application Number PCT/EP2024/057199, filed on 18 Mar. 2024, which claims priority to and the benefit of German Utility Model Application No. DE 20 2023 101 364.3, filed 19 Mar. 2023, the entire contents of which is incorporated herein by reference.

### TECHNICAL FIELD

The present disclosure relates to the field of processing pneumatic tires, for example passenger car tires or truck tires.

### BACKGROUND

DE 43 39 775 C2 discloses a method for correcting the concentricity of pneumatic tires and a device for clamping a tire suitable for carrying out the method. At least so much is removed from a radially inner seat surface of the tire bead that the remaining radial force fluctuations are then within a tolerance range. The removing is performed by a laser beam. A device for clamping a tire and for removal of rubber from the bead region is of rim-like configuration in cross section, having a first seat surface arranged radially on the inside and a further seat surface arranged axially on the outside, wherein the seat surface arranged radially on the inside is left open over a region of the circumference, so that a tool removing from the radially inner surface of the tire bead can be brought into contact with the bead within this region of the circumference. The region of the circumference over which the seat surface arranged radially on the inside is left open has an extent of 50 degrees to 160 degrees, preferably 90 degrees.

### SUMMARY

There may be a need for a technique that allows improved processing of a pneumatic tire.

This need may be addressed by the independent claims. Some advantageous embodiments are specified in the dependent claims.

According to a first aspect of the herein disclosed subject matter, a pneumatic tire is provided.

According to an embodiment of the first aspect, a pneumatic tire is provided, the pneumatic tire comprising: a bead having a bead base facing a rotational axis of the pneumatic tire; wherein the bead base comprises a protrusion extending toward the rotational axis and in a circumferential direction of the bead base; and wherein the protrusion has a geometry varying in the circumferential direction.

According to a second aspect of the herein disclosed subject matter, a method is provided.

According to an embodiment of the second aspect, a method for processing a pneumatic tire is provided, in particular for thereby producing a pneumatic tire according to at least one embodiment of the first aspect, wherein the pneumatic tire comprises a bead base, wherein the pneumatic tire defines an axial direction parallel to a rotational axis of the pneumatic tire and wherein the pneumatic tire defines a circumferential direction around the rotational axis, the method comprising: Removing tire material in a processing region of the bead base and thereby generating a protrusion extending toward the rotational axis and in the circumferential direction of the bead base and wherein the protrusion has a geometry varying in the circumferential direction.

According to a third aspect of the herein disclosed subject matter, a tire processing machine is provided.

According to an embodiment of the third aspect, a tire processing machine for processing a pneumatic tire is provided, in particular for thereby producing a pneumatic tire according to at least one embodiment of the first aspect, wherein the pneumatic tire to be processed comprises a first bead and a second bead, wherein the pneumatic tire defines an axial direction parallel to a rotational axis of the tire and wherein the pneumatic tire defines a circumferential direction around the rotational axis, the tire processing machine comprising: at least one first holding finger engageable with the first bead; at least one second holding finger engageable with the second bead; wherein the at least one first holding finger is operable to rotate the pneumatic tire, in particular together with the at least one first holding finger, with respect to the at least one second holding finger.

According to a fourth aspect of the herein disclosed subject matter, a method is provided.

According to an embodiment of the fourth aspect, a method for operating a tire processing machine for processing a pneumatic tire is provided, in particular for thereby producing a pneumatic tire according to at least one embodiment of the first aspect, wherein the pneumatic tire to be processed comprises a first bead and a second bead, wherein the pneumatic tire defines an axial direction parallel to a rotational axis of the pneumatic tire and wherein the pneumatic tire defines a circumferential direction around the rotational axis, the method comprising: engaging at least one first holding finger with the first bead; engaging at least one second holding finger with the second bead; operating the at least one first holding finger, in particular into a rotational movement, to rotate the pneumatic tire, in particular together with the at least one first holding finger, with respect to the at least one second holding finger.

According to a fifth aspect of the herein disclosed subject matter, a wheel is provided.

According to an embodiment of the fifth aspect, a wheel is provided, the wheel comprising a rim and a pneumatic tire according to the first aspect mounted on the rim.

According to a sixth aspect of the herein disclosed subject matter, a control device of a tire processing machine is provided.

According to an embodiment of the sixth aspect, the control device is configured to perform a method according to at least one embodiment of the second aspect and/or a method according to at least one embodiment of the fourth aspect.

According to a seventh aspect of the herein disclosed subject matter, a computer program product is provided.

According to an embodiment of the seventh aspect, a computer program product is provided, the computer program product comprising a program element configured to, when executed on a processor device, perform a method according to at least one embodiment of the second aspect and/or a method according to at least one embodiment of the fourth aspect.

### DESCRIPTION OF EXEMPLARY EMBODIMENTS

Although certain disadvantages of prior technologies are mentioned herein, the claimed subject matter is not intended to be limited to implementations that solve some or all of the mentioned disadvantages of the prior technologies. Furthermore, although certain advantages of the herein disclosed subject matter are mentioned or implied in the present disclosure, the claimed subject matter is not intended to be limited to implementations that have some or all of these advantages.

In the following, exemplary embodiments of the herein disclosed subject matter will be described, any number and combination of which can be realized in an implementation of aspects of the herein disclosed subject matter. In particular, exemplary implementations of the herein disclosed subject matter include at least one of the embodiments and combinations of embodiments described below:

According to an embodiment of the first aspect, a pneumatic tire has a bead having a bead base. As usual, the bead base faces the rotational axis of the pneumatic tire. In other words, the bead base is defined by a surface portion of the bead facing the rotational axis. According to an embodiment, if the pneumatic tire is mounted on a rim, the bead base rests on the rim. According to a further embodiment, the bead base—for example in the case of tubeless tires—seals the pneumatic tire against the rim.

According to an embodiment, the bead base comprises a protrusion extending toward the rotational axis and in the circumferential direction of the bead base. According to a further embodiment, the protrusion has a geometry varying in the circumferential direction.

According to an embodiment of the herein disclosed subject matter, the bead base comprises a surface structure generated by removal of tire material along processing tracks in a processing region of the bead base, wherein the surface structure is undulated.

According to an embodiment, the pneumatic tire and in particular the bead of the pneumatic tire defines an axial direction parallel to the rotational axis of the pneumatic tire and a circumferential direction around the rotational axis. As usual and according to an embodiment, the pneumatic tire has two beads, a first bead and a second bead.

According to an embodiment of the second aspect, a method for processing a pneumatic tire comprises removing of tire material (in particular rubber material) in a processing region of the bead base and thereby generating a protrusion, wherein the protrusion extends toward the rotational axis and in the circumferential direction and wherein the protrusion has a geometry varying in the circumferential direction.

According to an embodiment of the third aspect, a tire processing machine for processing a pneumatic tire comprises at least one first holding finger which is engageable with the first bead; and at least one second holding finger which is engageable with the second bead. According to an embodiment, the at least one first holding finger is operable to rotate the pneumatic tire together with the at least one first holding finger with respect to the at least one second holding finger.

According to an embodiment of the fourth aspect, a method for operating a tire processing machine comprises an engaging of at least one first holding finger with the first bead and an engaging of at least one second holding finger with the second bead. According to an embodiment, the method further comprises driving the at least one first holding finger into a rotational movement to rotate the pneumatic tire together with the at least one first holding finger with respect to the at least one second holding finger.

According to an embodiment of the fifth aspect, a wheel comprises a rim and a pneumatic tire according to at least one embodiment of the first aspect mounted on the rim.

According to an embodiment of the sixth aspect, a control device is configured to perform a method according to at least one embodiment of the second aspect and/or a method according to at least one embodiment of the fourth aspect.

According to an embodiment of the seventh aspect, a computer program is configured to, when executed on a processor device, perform a method according to at least one embodiment of the second aspect and/or a method according to at least one embodiment of the fourth aspect.

Above there has been and below there will be, in some embodiments, upon the first occurrence of a feature, made reference to the feature having the indefinite article, e.g. in the description of embodiments of different aspects of the herein disclosed subject matter. However, it should be understood that the use of the indefinite article in this disclosure is not limiting and that a feature referred to in different embodiments, whether referred to by the defined article or by the indefinite article, in any case relates, at least in an embodiment, to the same feature and therefore in a combination of different embodiments the feature may be referred to with the indefinite article upon the first occurrence of the feature and, upon the further occurrences of the feature, with the definite article. Furthermore, in one embodiment, the first aspect, the second aspect, the third aspect, the fourth aspect, the fifth aspect, the sixth aspect and the seventh aspect are at least partially different aspects of the same subject matter.

At least some of the aspects and embodiments of the herein disclosed subject matter are based on the idea that by a suitable targeted design in the bead base an improved processing of a pneumatic tire is enabled. Other aspects and embodiments of the herein disclosed subject matter are based on the idea of enabling the targeted design of the bead base by providing a suitable tire processing machine.

In the following, exemplary embodiments of the herein disclosed subject matter are described, wherein reference is made, for example, to a pneumatic tire, a method for processing a pneumatic tire, a tire processing machine, a method for operating a tire processing machine, a wheel, a control device and a computer program product. It should be emphasized that, of course, any combination of features of different aspects, embodiments and examples is possible. In particular, some embodiments are described with reference to a method, a control device and a computer program product, while other embodiments are described with reference to a device or a product, for example a pneumatic tire, a tire processing machine and a wheel. Again, other embodiments are described with reference to a mechanical construction, in particular with reference to a mechanical interaction of elements of a device and/or a product, while other embodiments are described with reference to a control device for interacting with elements of the device. However, a person skilled in the art will take from the above and the following description, claims and drawings that, unless otherwise specified, features of different aspects, embodiments and examples are combinable and such combinations of features are to be regarded as disclosed by this application. For example, even a feature which relates to a method is combinable with a feature which relates to a device or a product, and vice versa. Furthermore, features are also combinable independently of the location of disclosure, for example independently of whether the respective feature is disclosed in the general description, in the description of the drawings, the claims or in the drawings themselves.

According to one embodiment, a method disclosed herein may define the functionality of a device or a product disclosed herein without being limited to the device-specific features. In this regard, any functionality disclosed herein of a device or a product disclosed herein shall implicitly disclose a corresponding method which is defined solely by the disclosed functionality. Conversely, according to one embodiment, a method disclosed herein may be performed with any suitable known device (which may comprise a single element or a plurality of interacting elements). In this regard, any method disclosed herein shall implicitly disclose a corresponding device which is configured to perform the method or a product which is configured to result from the method.

It is pointed out that, unless expressly stated otherwise, numerals (first, second, third, etc.) merely serve to identify different elements (e.g., beads, rolls, etc.) without the numerals implying an order of method steps and without the numerals requiring or implying an existence of one of the other different elements. For example, a reference to a second roller alone does not require that a first roller is already present or provided at all.

Unless expressly stated otherwise, according to one embodiment, a listing of features or method steps does not yet define an order of the features or method steps in the sequence of the listing. However, according to a further embodiment, an order of the features or an order of the method steps corresponds to the stated sequence of the listing.

The phrase “A and/or B” encompasses the three embodiments “only A”, “only B”, as well as “A and B”. The term “in particular” denotes optional features. The term “at least one of the following” or “at least one of the following features” encompasses embodiments that each comprise only a single one of the stated features as well as further embodiments that comprise any combination of two or more of the stated features.

According to one embodiment, the varying geometry of the protrusion (of the bead base) extends over the entire circumference of the bead base, i.e. over an angular range of 360 degrees. According to one embodiment, the varying geometry of the protrusion (the bead base) extends over an angular range smaller than 360 degrees, for example over an angular range smaller than 180 degrees. For example, according to one embodiment, the angular range is in an interval between 20 degrees and 350 degrees. Thus, this embodiment encompasses both an angular range extending over 20 degrees (in this embodiment the minimum angular range) and an angular range extending over 350 degrees (in this embodiment the maximum angular range). According to one embodiment, the angular range is in an interval between 40 degrees and 160 degrees. According to one embodiment, the protrusion extends over an angular range disclosed herein, for example an angular range smaller than 360 degrees.

Embodiments of the herein disclosed subject matter allow processing over large angular ranges. Large angular ranges have the advantage that, for example, both a deviation from an ideal roundness of the pneumatic tire and a conicity of the pneumatic tire can be at least partially corrected by the complete processing of a bead base in one processing operation. As is familiar to those skilled in the art, the roundness of a tire denotes a deviation of the ideal distance of parts of the pneumatic tire from the axis of rotation. The roundness of the tire is therefore a geometric requirement which is to be distinguished from an imbalance of the tire which refers to the mass distribution. As is further familiar to those skilled in the art, the conicity of a tire denotes a different outer diameter of the pneumatic tire at different axial positions.

According to an embodiment, the protrusion is a first protrusion and the bead base comprises a second protrusion extending in the circumferential direction of the bead base. According to an embodiment, the first protrusion and the second protrusion are arranged at an (axial) distance from one another. According to an embodiment, the first protrusion and/or the second protrusion of the bead base is deformed by a rim on which the pneumatic tire is mounted. In this way, a tightness of the pneumatic tire with respect to the rim can be improved. Accordingly, in the wheel according to an embodiment, the protrusion of the bead base is deformed by the rim. For example, due to the rim the protrusion of the bead base (in particular the first protrusion and/or the second protrusion) comprises a circumferentially varying deformation.

According to an embodiment, the first protrusion and the second protrusion define between them a recess, in particular a recess which in the axial direction and/or in the circumferential direction is at least partially trough-shaped. For example, the first protrusion and the second protrusion extend over a same angular range. According to a further embodiment, the first protrusion can be offset with respect to the second protrusion in the circumferential direction. In other words, according to an embodiment, the first protrusion extends over a first angular range and the second protrusion extends over a second angular range, wherein the first angular range and the second angular range only partially overlap.

According to an embodiment, the recess in an axial direction can be formed unsymmetrically. For example, a transition from a bottom of the recess to the respective protrusion can be configured differently for the first protrusion and for the second protrusion.

According to an embodiment, the protrusion protrudes over a bottom (the bottom) of the bead base. In this case, in an embodiment, the geometry varying in the circumferential direction can encompass a height of the protrusion varying in the circumferential direction with respect to the bottom. According to an embodiment, a height of the protrusion with respect to the bottom is at most 1 mm, for example at most 0.5 mm. According to an embodiment, a difference of a height of the protrusion in the circumferential direction at an angular position to a height of the protrusion at another angular position with respect to the bottom is at most 1 mm, for example at most 0.5 mm. In another embodiment, a height of the protrusion with respect to the bottom or the difference is at most 0.3 mm. In a further embodiment, during the manufacture of the pneumatic tire, additional rubber material is provided on the bead base in order to provide more removal volume for non-roundnesses. In particular in this case, the height or the difference can be more than 1 mm, for example less than 1.5 mm or less than 2 mm.

According to an embodiment, the protrusion (for example the first protrusion and/or the second protrusion) is arranged in an axial boundary area of the bead base. The axial boundary areas of the bead base (i.e. the boundary areas of the bead base as seen in the axial direction) are frequently also referred to as the bead toe (in the case of the boundary area which faces an interior of the pneumatic tire) or as the bead heel (in the case of the boundary area which faces outward).

According to an embodiment, the protrusion (for example the first protrusion and/or the second protrusion) was generated by removal of tire material in a processing region (in particular the aforementioned processing region) of the bead base. According to an embodiment, the removal of tire material was performed with laser radiation, in particular with laser radiation of a CO2 laser. Generally, the removal can be a removal according to the herein disclosed embodiments, for example a removal for generating the protrusion and/or a removal for generating the surface structure.

According to an embodiment, the laser radiation (with which the removal was generated) was a continuous or quasi-continuous laser radiation (also referred to as CW laser radiation). According to a further embodiment, a power distribution of the laser radiation over the beam cross section of the laser radiation had a Gaussian profile. According to a further embodiment, the laser radiation had a power of more than 400 W. According to a further embodiment, the laser radiation had a power of more than 800 W. The power of the laser radiation emitted by a laser device is also referred to as the output power of the laser device (or “of the laser” for short).

According to an embodiment, the removal of tire material took place along at least one line. In the case of a continuous laser radiation, in this case a continuous removal is performed along the line. In the case of a pulsed laser radiation, a removal is performed by removal locations overlapping along the line (each laser pulse generates a removal in a removal location). By suitable overlap along the line, also in this way a nearly continuous removal along the line is possible. According to an embodiment, herein the term “line” refers to a line along which the laser radiation or the laser spot generated by the laser radiation is guided. The width of the removal along a line (i.e. the width of a removal region of a single line) is therefore determined by the width or the diameter of the laser radiation (or the laser spot generated by the laser radiation on the pneumatic tire). Since the removal is not a linear function of the intensity, the width of the removal region can be smaller than the width of the laser spot.

According to an embodiment, the laser radiation is configured such that a width of the removal along a single line (i.e. the width of a removal region of a single line) corresponds to a desired total width of the removal (i.e. a width of the processing region). For example, according to an embodiment, the width of the removal region along a single line corresponds to the width of the recess. It is noted that in this case the width is always determined in the axial direction. Furthermore, it is noted that in the case of a Gaussian intensity distribution over the beam cross section of the laser radiation, the width of the removal region of a single line corresponds approximately to the 1/e2 diameter of the laser radiation.

According to an embodiment, the removal of tire material took place along a plurality of parallel lines. In this way, in a transverse direction which runs transversely with respect to the longitudinal direction of the parallel lines, a removal can extend over region which is larger in the transverse direction than the extent of the removal region of a single line in the transverse direction.

According to an embodiment, the parallel lines enclose an angle with the axial direction in a range between 0 degrees and 60 degrees. According to a further embodiment, the parallel lines extend in the circumferential direction. Thus, according to an embodiment, the removal regions or the processing tracks also enclose an angle with the axial direction in a range between 0 degrees and 60 degrees or extend in the circumferential direction.

According to an embodiment, the removal regions of neighboring lines overlap. For example, according to an embodiment, an overlap of removal regions of neighboring lines is between 10% and 90%. According to a further embodiment, an overlap of removal regions of neighboring lines is between 65% and 85%. For example, an overlap of removal regions of neighboring lines is 10%, 20%, 33.333%, 50%, 66.667%, 80% or 90%. For example, an overlap of removal regions of neighboring lines is 80%.

According to an embodiment, the overlap of removal regions of neighboring lines is constant. For example, the overlap of removal regions of two neighboring lines is always 80% for all parallel lines of the plurality of parallel lines.

According to a further embodiment, the overlap of removal regions of neighboring lines depends on a depth of the removal. For example, according to an embodiment, the greater the depth of the removal, the greater an overlap of removal regions of neighboring lines, and vice versa. For example, a greater depth of the removal can be achieved by a greater overlap of removal regions of neighboring lines.

According to an embodiment, the depth of the removal varies continuously in the circumferential direction.

According to an embodiment, a variation of a depth of the removal in the circumferential direction and/or in the axial direction has been achieved at least partially by a variation of a power of the laser radiation. A variation of the power of the laser radiation for varying the depth of the removal has the advantage that the overlap of the individual removal lines can be kept constant and the process control is less complex.

The laser radiation generates a laser spot (also referred to as “spot” for short) on a surface of the pneumatic tire, in particular on a surface of the bead base. The region of the surface illuminated by the laser spot is also referred to herein as processing location. According to an embodiment, a variation of a depth of the removal in the circumferential direction and/or in the axial direction has been achieved at least partially by a variation of the traverse speed of the laser spot over the tire surface. This has the advantage that the entire process according to an embodiment can be performed with constant maximum laser power and thus higher efficiency. In particular, according to an embodiment, a variation of a depth of the removal in the circumferential direction and/or in the axial direction was achieved at least partially by a variation of a traverse speed of the laser spot over the surface of the bead base.

According to an embodiment, the bead comprises a surface structure in the processing region, for example the surface structure according to embodiments described herein.

According to an embodiment, the surface structure has been generated by removal of tire material along processing tracks in the processing region. According to an embodiment, the processing tracks correspond to the removal regions of the lines, for example the removal regions of neighboring lines.

According to an embodiment, the surface structure is undulated. For example, the surface structure comprises a plurality of wave crests, which alternate with wave troughs, so that a wave trough lies between two wave crests.

According to an embodiment, the wave crests of the surface structure are arranged at least partially parallel to each other. According to an embodiment, the wave crests extend generally parallel to each other, according to an embodiment with deviations from an exact parallelism. It is pointed out that the undulated surface structure is not necessarily a symmetrical surface structure in the sense of a sinusoidal shape. Rather, according to an embodiment, the wave shape of the surface structure deviates from a sinusoidal shape. For example, according to an embodiment, the wave shape is characterized by wave crests, which are narrower than the wave troughs. Further, in an embodiment, the wave crests can be tapered, while the wave troughs can be formed flat.

According to an embodiment, the surface structure comprises a first structure portion and/or a second structure portion. For example, the surface structure can comprise solely the first structure portion or solely the second structure portion or comprise both the first structure portion and the second structure portion. For example, the surface structure can comprise a superposition of the first structure portion and the second structure portion.

According to an embodiment, the first structure portion comprises wave crests defined by an overlap of the processing tracks. For example, the overlap of the processing tracks (i.e. the removal regions of the parallel lines) is between 10% and 90% of the width of the processing tracks. According to an embodiment, the wave crests of the first structure portion extend lengthwise the processing tracks.

According to an embodiment, the second structure portion comprises wave crests at a distance that is greater than a width of the processing tracks. According to an embodiment, a geometry of the wave crests of the second structure portion varies in a longitudinal direction of the wave crests.

According to an embodiment, a distance between the wave crests of the first structure portion is greater than 0.05 mm. According to a further embodiment, the distance between the wave crests of the first structure portion is less than 2 mm. According to a further embodiment, the distance between the wave crests of the second structure portion is greater than 0.5 mm. According to a further embodiment, the distance between the wave crests of the second structure portion is less than 10 mm. According to a further embodiment, an amplitude of the surface structure is between 0.005 mm (=5 μm) and 0.25 mm (=250 μm).

According to an embodiment, the amplitude of the surface structure varies in the circumferential direction. For example, starting from a location of maximum amplitude, the amplitude of the surface structure decreases continuously in the circumferential direction, according to an embodiment in both directions, i.e. starting from the location of maximum amplitude both in the circumferential direction and opposite to the circumferential direction. According to an embodiment, the amplitude of the surface structure is modulated in the circumferential direction, with one or more local maxima/minima in the amplitude.

According to an embodiment, at least an boundary area of the bead base (for example the bead toe and/or the bead heel) is free of the surface structure. According to an embodiment, in the processing region a recess is formed in the bead base. In other words, the processing of the bead base (e.g. the removal of tire material) in the processing region results in a recess. In particular, the production of the surface structure according to an embodiment results in a recess in the bead base. In an embodiment, according to which the processing region does not extend up to the boundary area of the bead base, the removal in the processing region results in a protrusion according to embodiments of the herein disclosed subject matter.

In particular, embodiments are described below with regard to the second aspect, wherein the respective embodiments are, of course, also embodiments of the other aspects.

According to the above statements, the removal of tire material according to an embodiment is performed over an angular range which is smaller than 360 degrees. Thus, the protrusion according to an embodiment extends over an angular range which is smaller than 360 degrees.

According to an embodiment, the pneumatic tire is rotated about its rotational axis during the removing of tire material. In this way, for example, according to an embodiment, a source of the laser radiation and/or a suction device can be positioned in a stationary manner during the processing of the first bead or of the second bead. According to an embodiment, tire material is removed multiple times in a part of the processing region. If, for example, the power of the laser radiation is not sufficient to achieve the desired depth at a certain processing speed, by multiple removal of tire material nearly any desired depth of the removal can be realized.

According to an embodiment, the protrusion is a first protrusion and the removing of tire material in the processing region generates a second protrusion extending in the circumferential direction. According to an embodiment, the processing region is arranged between the first protrusion and the second protrusion and thereby defines a recess between the first protrusion and the second protrusion. According to an embodiment, the recess in the axial direction and/or in the circumferential direction is at least partially trough-shaped. According to an embodiment, the removing of the tire material is performed up to a depth and the depth varies in the circumferential direction of the protrusion. Consequently, according to an embodiment, the geometry varying in the circumferential direction can encompass a depth of the recess varying in the circumferential direction. In an embodiment, this depth of the recess corresponds to the height of the protrusion with respect to the bottom. The statements regarding the height of the protrusion therefore apply accordingly to the depth of the recess, and vice versa. According to a further embodiment, the depth of the recess corresponds to the removal depth, i.e. the depth over which tire material was removed from the bead base. According to an embodiment, the variation of the depth over the circumferential direction can be generated by combining more than one harmonic oscillation which differ in maximum amplitude and frequency, respectively, for example by combining 2, 3 or 4 such harmonic oscillations. According to an embodiment, the desired variation of the removal depth is defined as a combination of multiple harmonic oscillations in the form of the Fourier transform of this desired removal function.

According to a further embodiment, the symmetry of the recess in an axial direction can vary lengthwise the circumferential direction. For example, according to an embodiment, the symmetry in the axial direction can depend on the average removal depth in the circumferential direction. Thus, for example, according to a further embodiment, lengthwise the circumferential direction at angular positions at which a minimum removal is present, the recess in the axial direction can be uniform and/or symmetrical.

According to an embodiment, the processing region comprises a central region of the bead base, wherein the central region of the bead base in the axial direction is arranged between boundary areas of the bead base. According to a further embodiment, the processing region exists in the central region of the bead base. In other words, according to an embodiment, boundary areas of the bead base (which delimit the bead base in the axial direction) are not part of the processing region.

According to an embodiment, the removal of tire material is performed with laser radiation, in particular laser radiation of a CO2 laser. According to an embodiment, the CO2 laser is operated continuously during the removing. According to a further embodiment, the CO2 laser has a Gaussian intensity profile over its beam cross section. According to a further embodiment, the CO2 laser has an output power of more than 400 W. For example, according to an embodiment, the CO2 laser has an output power of more than 800 W.

According to an embodiment, the removing of the tire material is performed along at least one line. For example, according to an embodiment, the removing of the tire material is performed along a single line. According to a further embodiment, the removing of the tire material is performed along a plurality of lines, in particular a plurality of parallel lines. According to an embodiment, the parallel lines enclose an angle with the axial direction in a range between 0 degrees and 60 degrees. According to a further embodiment, the parallel lines extend in the circumferential direction.

According to an embodiment, the removing of the tire material along the line defines a removal region. According to an embodiment, removal regions of neighboring lines overlap. For example, according to an embodiment, a 1/e2 diameter of the laser radiation is greater than a pitch distance between the parallel lines.

According to an embodiment, an overlap of removal regions of neighboring lines is between 10% and 90%. Accordingly, according to an embodiment, the pitch distance of neighboring lines is between 90% and 10% of the 1/e2 diameter of the laser radiation. According to a further embodiment, an overlap of removal regions of neighboring lines is between 65% and 85%. Accordingly, according to an embodiment, the pitch distance of neighboring lines is between 35% and 15% of the 1/e2 diameter of the laser radiation. According to a further embodiment, an overlap of removal regions of neighboring lines is 10%, 20%, 33.333%, 50%, 66.667%, 80% or 90%. Accordingly, according to an embodiment, the pitch distance of neighboring lines is between 90%, 80%, 66.667%, 50%, 33.333%, 20% or 10% of the 1/e2 diameter of the laser radiation. According to an embodiment, the overlap of removal regions of neighboring lines corresponds to an overlap of neighboring processing tracks.

According to an embodiment, the overlap of removal regions of neighboring lines is constant. Accordingly, according to an embodiment, a pitch distance of neighboring lines is constant.

According to an embodiment, the overlap of removal regions of neighboring lines depends on a depth of the removal. According to an embodiment, during the removing of tire material in the processing region a power of the laser radiation is varied dependent on a position in the axial direction and/or dependent on a position in the circumferential direction. According to a further embodiment, during the removing of tire material in the processing region a traverse speed, i.e. the speed at which the laser spot is guided over the bead base, is varied dependent on a position in the axial direction and/or dependent on a position in the circumferential direction. According to an embodiment, during the removing of the tire material a rotation of the pneumatic tire about the rotational axis is performed, in particular a rotation at a constant angular speed.

According to an embodiment, the rotation of the pneumatic tire about the rotational axis is compensated for in a positioning of the laser radiation in the processing region. For example, in order to generate parallel lines in the axial direction, the laser radiation is guided at a circumferential speed of the bead base in the rotation direction, followed by a back jump opposite to the rotation direction, in order to then again generate a parallel line in the reverse direction (opposite to the axial direction), while laser radiation is guided at the circumferential speed of the bead base in the rotation direction. After a further back jump, this process is repeated until the desired number of parallel lines has been generated.

If the parallel lines are not to run parallel to the axial direction, but at an acute angle to the axial direction, the process is performed analogously, wherein the laser radiation is then guided at a higher speed than the circumferential speed of the bead base in the rotation direction, in order to generate the acute angle between the axial direction and the parallel lines.

The guiding of the laser radiation parallel to the circumferential direction (i.e. in the rotation direction and counter to the rotation direction) as well as the back jump parallel to the circumferential direction (i.e. in the rotation direction and counter to the rotation direction can be realized, for example, by a laser scanner (also referred to herein for short as “scanner”), for example a galvanometer scanner. According to an embodiment, the laser radiation is switched off for the back jump (power of the laser radiation equal to 0 W).

Embodiments of the herein disclosed subject matter relate to receiving the pneumatic tire in a tire processing machine and, respectively, the way in which the pneumatic tire is held and moved in order to enable processing, as disclosed herein, of the pneumatic tire in an efficient manner.

According to an embodiment of a method, at least one first holding finger is engaged with a first bead of the pneumatic tire and at least one second holding finger is engaged with a second bead of the pneumatic tire.

In according to an embodiment, at least two first holding fingers and at least two second holding fingers are provided. In a further embodiment, at least three first holding fingers and three second holding fingers are provided. At least three holding fingers have the advantage that they define a plane and thus a spatial position of the respective bead is defined by the at least three holding fingers. A greater number of holding fingers, for example four holding fingers, six holding fingers or eight holding fingers per bead have the advantage that deformation of the bead due to gravity can be avoided, in particular also in an embodiment in which the pneumatic tire is processed in a horizontal arrangement (i.e. in an arrangement in which the rotational axis extends parallel to the direction of gravity).

Thus, the term “at least one first holding finger” explicitly encompasses also the embodiments “at least two first holding fingers”, “at least three first holding fingers”, “at least four first holding fingers”, “at least six first holding fingers” and “at least eight first holding fingers”, as well as the term “a set of first holding fingers”, wherein the set of first holding fingers encompasses according to an embodiment at least one first holding finger, at least two first holding fingers, at least three first holding fingers, at least four first holding fingers, at least six first holding fingers or at least eight first holding fingers.

Accordingly, the term “at least one second holding finger” explicitly encompasses also the embodiments “at least two second holding fingers”, “at least three second holding fingers”, “at least four second holding fingers”, “at least six second holding fingers” and “at least eight second holding fingers”, as well as the term “a set of second holding fingers”, wherein the set of second holding fingers encompasses according to an embodiment at least one second holding finger, at least two second holding fingers, at least three second holding fingers, at least four second holding fingers, at least six second holding fingers or at least eight second holding fingers.

According to an embodiment, the pneumatic tire is held solely by the at least one first holding finger and/or the at least one second holding finger. According to a further embodiment, in addition to the at least one first holding finger and/or the at least one second holding finger, further holding elements are provided.

According to an embodiment, a distance between the first bead and the second bead is adjusted by a positioning of the at least one first holding finger and the at least one second holding finger relative to each other. For example, according to an embodiment, the pneumatic tire can be spread in the axial direction, i.e. a distance between the first bead and the second bead is adjusted by means of the set of first holding fingers and the set of second holding fingers to a value which is greater than a nominal distance between the first bead and the second bead after the mounting on a rim. By spreading the tire in the axial direction, processing of the tire can be facilitated.

According to an embodiment, a rotating of the pneumatic tire during the removing of the tire material is performed by a driving of the at least one first holding finger (or by a driving of the set of first holding fingers) into a rotational movement.

According to an embodiment, the set of first holding fingers thus fulfills two functions: firstly the positioning of the first bead of the pneumatic tire and secondly the driving of the first bead of the pneumatic tire into a rotational movement.

According to an embodiment, during the driving of the at least one first holding finger into a rotational movement, the second bead is in rolling engagement with the at least one second holding finger, for example by releasing at least one roller of the at least one second holding finger. In other words, according to an embodiment, during the driving of the at least one first holding finger into a rotational movement, the second bead is supported rolling on the at least one second holding finger and the removing (of tire material) is performed on the second bead.

The fact that the bead, from which the removing of tire material is performed (in the above embodiment the second bead), is supported rolling on the respective at least one (second) holding finger has the advantage that the respective (second) holding fingers can remain unchanged in their position and thus the laser radiation can be directed between two neighboring holding fingers onto the bead. Also a suction device can thus during the removing be positioned in a stationary manner with respect to the bead to be processed and between two neighboring holding fingers. Thus, generally speaking, according to an embodiment, the bead to be processed is guided past the laser radiation and the suction device by the rotational movement of the pneumatic tire.

According to a further embodiment, after the removing of tire material from the second bead, the removing of tire material from the first bead is performed. According to an embodiment, a rotating of the pneumatic tire during the removing from the first bead is performed by a driving of the at least one second holding finger into a rotational movement. For example, the at least one second holding finger is in frictional engagement with the pneumatic tire during the driving into a rotational movement, for example by a blocking of at least one roller of the at least one second holding finger.

As set forth above, the first holding finger (for example each of the at least one first holding finger or at least one of the at least one first holding finger) and/or the second holding finger (for example each of the at least one second holding finger or at least one of the at least one second holding finger) can comprise at least one roller. For example, the roller (of which the respective holding finger can comprise one or more) can be blockable in order to prevent a rotating of the roller, for example in order to bring the first holding finger into a frictional engagement with the pneumatic tire. According to a further embodiment, the roller can be releasable in order to allow a rotating of the roller, for example in order to bring the first holding finger and the roller into a rolling engagement.

According to an embodiment, during the driving of the at least one second holding finger into a rotational movement, the first bead is in rolling engagement with the at least one first holding finger.

The provision of holding fingers can allow an efficient handling of the pneumatic tire.

According to an embodiment, the at least one first holding finger is engaged with the first bead of the pneumatic tire by moving the at least one first holding finger in a first transverse direction (for example along the axial direction) into the pneumatic tire and subsequently moving the at least one first holding finger in a direction towards the first bead. Analogously, according to a further embodiment, the at least one second holding finger is engaged with the second bead of the pneumatic tire by moving the at least one second holding finger in a second transverse direction (for example along the axial direction) into the pneumatic tire and subsequently moving the at least one second holding finger in a direction towards the second bead.

According to an embodiment, the at least one first holding finger is mounted at a carrier (also referred to herein as first carrier). According to a further embodiment, the at least one second holding finger is mounted on a second carrier.

According to an embodiment, the at least one first holding finger is moved in the first transverse direction into the pneumatic tire by lifting the carrier. The carrier may for example be arranged below a transport device according to an embodiment. According to an embodiment, the transport device is configured to position the pneumatic tire in the tire processing machine.

According to an embodiment, for the driving of the at least one first holding finger into a rotational movement, the carrier is lifted over the transport device. According to an embodiment, subsequently the carrier (and thus also the holding fingers mounted thereon) is driven into the rotational movement.

According to a further embodiment, the at least one roller may be drivable to drive the pneumatic tire into a rotational movement relative to the holding finger. In other words, according to an embodiment, the respective holding finger is operable by the driving of its roller to drive the pneumatic tire into a rotational movement relative to the holding finger. In other words, in this case the driving holding finger does not move together with the pneumatic tire. According to an embodiment, the tire processing machine according to the third aspect comprises in particular at least one first holding finger which is engageable with the first bead, and at least one second holding finger which is engageable with the second bead. According to an embodiment, the at least one first holding finger is operable to rotate the pneumatic tire (for example together with the at least one first holding finger) with respect to the at least one second holding finger (i.e. to drive the pneumatic tire into a rotational movement with respect to the at least one second holding finger). As already explained herein, this embodiment allows a beam path of the laser radiation and/or a suction device to be positioned in a stationary manner with respect to the second holding fingers and nevertheless allows a processing of the second bead over its entire circumference. It is understood that according to embodiments this possibility of the processing over the entire circumference (i.e. over 360 degrees) is not exhausted in every case, but in accordance with some embodiments a processing of the respective bead (here the second bead) is performed only over a limited angular range, for example over an angular range of 270 degrees.

According to an embodiment, the at least one second holding finger is operable to rotate the pneumatic tire (for example together with the at least one second holding finger) with respect to the at least one first holding finger (i.e. to drive the pneumatic tire into a rotational movement with respect to the at least one first holding finger). For example, according to an embodiment it may be provided to selectively drive the pneumatic tire either via the at least one first holding finger into the rotational movement or via the at least one second holding finger into the rotational movement.

According to an embodiment, the at least one first holding finger and/or the at least one second holding finger is configured to hold the first bead and the second bead at a predetermined distance. As described herein, for example it may be provided that the at least one first holding finger and/or the at least one second holding finger is configured to spread the pneumatic tire in the axial direction.

According to an embodiment, the at least one first holding finger is configured for insertion of the at least one first holding finger into the pneumatic tire from a first side of the pneumatic tire. According to a further embodiment, the at least one second holding finger is configured for insertion of the at least one second holding finger into the pneumatic tire from a second side of the pneumatic tire. According to an embodiment, the second side of the pneumatic tire is arranged opposite to the first side of the pneumatic tire. For example, the pneumatic tire comprises a first sidewall and a second sidewall, which face away from one another, wherein the first side of the pneumatic tire faces the first sidewall of the pneumatic tire and the second side faces the second sidewall of the pneumatic tire.

According to an embodiment, the tire processing machine comprises a suction device. For example, according to an embodiment, the suction device is bringable into a first position for suctioning process residues of a processing of the first bead. According to a further embodiment, the suction device is bringable into a second position for suctioning process residues of a processing of the second bead. According to a further embodiment, the suction device comprises a brush head, which during the relative rotational movement of the tire against the suction device is guided chronologically after the laser over the processing location. For example, a brush head of the suction device is arranged trailing with respect to the suction device. The brush head serves to remove possibly adhering process residues.

According to an embodiment, the tire processing machine comprises at least two of the first holding fingers and the suction device is positionable between two neighboring first holding fingers. Alternatively or additionally, the tire processing machine can comprise at least two of the second holding fingers, wherein the suction device is positionable between two neighboring second holding fingers. As already described above, a spatial position of the holding fingers, between which the suction device is positioned, can remain unchanged during the processing. For example, according to an embodiment, the spatial position of the first holding fingers, between which the suction device is positioned, is unchanged during the processing of the first bead. Furthermore, according to an embodiment, the spatial position of the second holding fingers, between which the suction device is positioned, can be unchanged during the processing of the second bead.

According to an embodiment, the tire processing machine comprises a laser emitting device for emitting laser radiation onto the pneumatic tire for thereby processing the pneumatic tire. According to an embodiment, the laser emitting device is arranged radially outside the pneumatic tire. In this way, a flexibility of the design and/or a flexibility of the positioning of the laser emitting device is increased since the laser emitting device does not have to be accommodated within the pneumatic tire.

According to an embodiment, the laser emitting device comprises at least one scanner for moving a beam path of the laser radiation over the pneumatic tire. The movement of the beam path by means of the at least one scanner is also referred to herein as “scanning movement of the beam path” (or for short as “scanning movement”). According to an embodiment, the at least one scanner is configured for moving the beam path with a directional component parallel to the rotational axis. In other words, according to an embodiment, the scanning movement comprises a directional component parallel to the rotational axis. According to a further embodiment, the scanning movement comprises a directional component in the circumferential direction.

According to an embodiment, the laser emitting device is configurable for processing a bead base of the first bead. Alternatively or additionally, the laser emitting device is configurable for processing a bead base of the second bead. Alternatively or additionally, the laser emitting device is configurable according to an embodiment for processing an inner surface of the pneumatic tire. For example, the laser emitting device can be configurable according to an embodiment for processing an inner surface section of the pneumatic tire, which faces away from a tread surface of the pneumatic tire.

According to an embodiment, the tire processing machine comprises a transport device, for example a transport device on which the pneumatic tire is transportable in a lying manner. In the sense of an embodiment of the present disclosure, the orientation indication “lying” means that the rotational axis of the pneumatic tire runs parallel to gravity or nearly parallel to gravity. According to an embodiment, the orientation indication “lying” means that a sidewall of the pneumatic tire faces the transport device. According to an embodiment, the sidewall of the pneumatic tire rests on the transport device (and not for instance a tread surface of the pneumatic tire rests on the transport device). According to an embodiment, the pneumatic tire rests on the transport device such that a barcode applied in the region of a bead is oriented upward on the pneumatic tire, i.e. away from the transport device. According to an embodiment, the barcode serves as a reference point in the tire circumferential direction for determining the angular position of the removal of the tire material (rubber material).

According to an embodiment, the at least one first holding finger and the at least one second holding finger are engageable with the pneumatic tire lying on the transport device.

According to an embodiment, the pneumatic tire is liftable by the at least one first holding finger and/or by the at least one second holding finger from the transport device to a lifted position such that a sidewall of the pneumatic tire faces the transport device at a distance. According to an embodiment, the laser emitting device is configured for processing the pneumatic tire in the lifted position.

According to an embodiment, the at least one first holding finger comprises a mechanical stop for a surface portion (also referred to herein as first surface portion) of the first bead. Alternatively or additionally, the at least one second holding finger comprises a mechanical stop for a surface portion (also referred to herein as second surface portion) of the second bead. According to an embodiment, the mechanical stop (of a first holding finger and/or of a second holding finger) is formed by a roller as described herein. In particular, the roller which forms the mechanical stop can be releasable or blockable as described herein. By means of a rolling engagement of the respective surface portion (i.e. of the first surface portion or of the second surface portion) with the roller, a mechanical loading of the respective surface portion with respect to a sliding engagement is reduced.

For example, at least one of the at least one holding finger comprises at least one roller on which the first surface portion is rollable and/or at least one of the at least one second holding finger comprises at least one roller on which the second surface portion is rollable. For easier differentiation, the at least one roller on which the first surface portion (of the first bead) is rollable is referred to below as first roller and the at least one roller on which the second surface portion (of the second bead) is rollable is referred to as second roller. It is pointed out that this designation with numerals is merely intended to facilitate the assignment or to shorten the phrases. In the description of the drawings, the designation first roller and second roller are used in a different sense—but also merely in order to facilitate the assignment or to shorten the phrases.

According to an embodiment, the tire processing machine comprises at least one of the following features: on at least one of the at least one first roller, a lateral bead part of the first bead is rollable; on at least one of the at least one first roller, a bead base of the first bead is rollable; on at least one of the at least one second roller, a lateral bead part of the second bead is rollable; on at least one of the at least one second roller, a bead base of the second bead is rollable; at least one of the at least one first roller is blockable in its rotation for a frictional engagement of the pneumatic tire and the first roller; at least one of the at least one second roller is blockable in its rotation for a frictional engagement of the pneumatic tire and the second roller; at least one of the at least one first roller is drivable into a rotation for driving the pneumatic tire into a rotational movement; at least one of the at least one second roller is drivable into a rotation for driving the pneumatic tire into a rotational movement. According to an embodiment, the lateral bead part of the first bead is a bead part extending transversely with respect to the bead base of the first bead and adjoining the bead base of the first bead. According to a further embodiment, the lateral bead part of the second bead is a bead part extending transversely with respect to the bead base of the second bead and adjoining the bead base of the second bead.

According to an embodiment, the at least one first holding finger at a distance from the rotational axis is rotatable by at least 360 degrees about the rotational axis. Alternatively or additionally, according to a further embodiment, the at least one second holding finger at a distance from the rotational axis is rotatable by at least 360 degrees about the rotational axis. For example, for this purpose, as described herein, the at least one first holding finger is mounted on a first carrier and/or the at least one second holding finger is mounted on a second carrier. By rotating the respective carrier (i.e. the first carrier or the second carrier), the holding fingers mounted at the carrier are rotatable.

According to an embodiment, the first holding fingers are movably mounted on the first carrier. For example, according to an embodiment, the first holding fingers on the first carrier are movable towards one another and away from one another. For example, according to an embodiment, the first holding fingers are movable towards one another for insertion of the first holding fingers into the pneumatic tire. Furthermore, according to an embodiment, the first holding fingers are movable away from one another for engaging the first holding fingers with the first bead of the pneumatic tire. Accordingly, according to an embodiment, the second holding fingers are movable towards one another for insertion of the second holding fingers into the pneumatic tire. Furthermore, according to an embodiment, the second holding fingers are movable away from one another for engaging the second holding fingers with the second bead of the pneumatic tire.

As described herein, the rotation of the carrier or the respective holding fingers mounted at the carrier is performed about an axis of rotation of the tire. Of course, however, as in any technical process or in any real implementation of a device, deviations are possible. In particular, due to the advantageous configuration of the tire processing machine, precise processing of the pneumatic tire is also possible when the axis of rotation of the carrier or the respective holding fingers deviates from the axis of rotation of the tire. In this regard, a reference to the axis of rotation of the pneumatic tire within the scope of the present disclosure also encompasses a reference to an axis which deviates from the axis of rotation of the pneumatic tire as long as the functionality defined herein of the respective embodiments is achieved.

According to embodiments of the first aspect, the pneumatic tire is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the second aspect, the method is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the third aspect, the tire processing machine is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the fourth aspect, the method for operating a tire processing machine is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the fifth aspect, the wheel is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the sixth aspect, the control device is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to embodiments of the seventh aspect, the computer program product is configured to provide the functionality of one or more of the embodiments disclosed herein and/or to provide the functionality as results from one or more of the embodiments disclosed herein and/or to provide the functionality as required for one or more of the embodiments disclosed herein, in particular the embodiments of the first aspect, the second aspect, the third aspect, the fourth aspect, the fifth aspect, the sixth aspect and/or the seventh aspect.

According to an embodiment, the computer program product is a non-transient computer program product. According to an embodiment, the program element is a non-transient program element.

As used herein, reference to a computer program product comprising a program element is considered equivalent to a reference to a computer program comprising the program element and/or a computer readable medium comprising the program element. According to an embodiment, the program element comprises instructions for controlling a processor device (with one or more microprocessors, for example a computer system), for causing and/or coordinating the execution of at least one method described herein.

The (non-transient) program element may be implemented as computer readable instruction code using any suitable programming language, such as JAVA, C#, Python, etc., and may be stored on a computer readable medium (removable disk, volatile or non-volatile memory, embedded memory/processor, etc.). According to an embodiment, the instruction code is executable for programming a computer or any other programmable processor device to perform the intended functions. The computer program may be available on a network, for example the World Wide Web, from which it may, for example, be downloaded.

Suitable embodiments of the herein disclosed subject matter (for example a function of the control device) may be realized by means of a computer program product (program element) or software, respectively. However, suitable embodiments may also be realized by one or more specific electronic circuits or respectively hardware. Furthermore, suitable embodiments may also be realized in hybrid form, i.e. in a combination of software modules and hardware modules.

Unless otherwise specified, numerical values including a ±5% window are to be understood according to an embodiment. For example, an indication of an angle of 10 degrees according to an embodiment encompasses an angle within an interval of (10±5%) degrees=[9.5 degrees; 10.5 degrees]. Similarly, a percentage indication according to an embodiment encompasses a percentage indication within a ±5% window. For example, an indication of 50% according to an embodiment encompasses a window of 50%±5%=[47.5%; 52.5%]. According to a further embodiment, numerical values including a ±10% window are to be understood.

Further exemplary embodiments and combinations of embodiments encompass the following:
1. A pneumatic tire comprising:
   a bead having a bead base facing the rotational axis of the pneumatic tire;
   wherein the bead base comprises a protrusion extending toward the rotational axis and in a circumferential direction of the bead base; and
   wherein the protrusion has a geometry varying in the circumferential direction.
2. The pneumatic tire according to embodiment 1, wherein the varying geometry of the protrusion extends over an angular range that is smaller than 360 degrees, in particular smaller than 180 degrees.
3. The pneumatic tire according to embodiment 2, wherein the angular range is in an interval between 20 degrees and 350 degrees, in particular between 40 degrees and 160 degrees.
4. The pneumatic tire according to one of embodiments 1 to 3,
   wherein the protrusion is a first protrusion and the bead base comprises a second protrusion extending in the circumferential direction of the bead base; and
   wherein the first protrusion and the second protrusion define between them a recess, in particular a recess which is in an axial direction and/or in the circumferential direction at least partially trough-shaped;
   in particular wherein the recess in an axial direction is formed unsymmetrically.
5. The pneumatic tire according to one of embodiments 1 to 4,
   wherein the protrusion protrudes over a bottom of the bead base;
   further comprising at least one of the following:
   the geometry varying in the circumferential direction comprises a height of the protrusion varying in the circumferential direction with respect to the bottom;
   a difference of a height of the protrusion at an angular position in the circumferential direction to a height of the protrusion at another angular position with respect to the bottom is at most 1 mm, for example at most 0.5 mm.
6. The pneumatic tire according to one of embodiments 1 to 5, wherein the protrusion is arranged in an axial boundary area of the bead base.
7. The pneumatic tire according to one of embodiments 1 to 6, wherein the protrusion was generated by removal of tire material in a processing region of the bead base.
8. The pneumatic tire according to embodiment 7, wherein the removal of tire material was performed with laser radiation, in particular laser radiation of a CO2 laser, in particular wherein
   the laser radiation was a continuous laser radiation; and/or
   the laser radiation had a Gaussian beam profile; and/or
   the laser radiation had a power of more than 400 W, in particular more than 800 W.
9. The pneumatic tire according to embodiment 7 or 8, wherein the removal of tire material was performed along at least one line.
10. The pneumatic tire according to embodiment 9, wherein the removal of tire material was performed along a plurality of parallel lines;
   in particular wherein the parallel lines enclose with an axial direction an angle in a range between 0 degrees and 60 degrees or the parallel lines extend in the circumferential direction.
11. The pneumatic tire according to embodiment 10, wherein removal regions of neighboring lines overlap.
12. The pneumatic tire according to embodiment 11, further comprising one of the following features:
   an overlap of removal regions of neighboring lines is between 10% and 90%;
   an overlap of removal regions of neighboring lines is between 65% and 85%;
   an overlap of removal regions of neighboring lines is 10%, 20%, 33.333%, 50%, 66.667%, 80%, or 90%.
13. The pneumatic tire according to one of embodiments 11 or 12, wherein the overlap of removal regions of neighboring lines is constant.
14. The pneumatic tire according to one of embodiments 11 or 12, wherein the overlap of removal regions of neighboring lines is dependent on a depth of the removal.
15. The pneumatic tire according to one of embodiments 7 to 14, wherein a depth of the removal varies continuously in the circumferential direction.
16. The pneumatic tire according to one of embodiments 8 to 15, wherein a variation of a depth of the removal in the circumferential direction and/or in the axial direction was achieved at least partially by a variation of a power of the laser radiation and/or by a variation of a traverse speed of a laser spot over a surface of the bead base, wherein the laser radiation generates the laser spot on the surface of the bead base.
17. The pneumatic tire according to one of embodiments 7 to 16, wherein the bead in the processing region has a surface structure.
18. The pneumatic tire according to embodiment 17,
   wherein the surface structure was generated by removal of tire material along processing tracks in the processing region; and/or
   wherein the surface structure is undulated.
19. The pneumatic tire according to embodiment 18, wherein
   the surface structure comprises a first structure portion and/or a second structure portion;
   wherein the first structure portion comprises wave crests defined by an overlap of the processing tracks and wherein the overlap is between 10% and 90% of a width of the processing tracks; and
   the second structure portion comprises wave crests at a distance which is greater than a width of the processing tracks.
20. The pneumatic tire according to embodiment 19, further comprising at least one of the following features:
   a distance between the wave crests of the first structure portion is greater than 0.05 mm;
   a distance between the wave crests of the first structure portion is less than 2 mm;
   the distance between the wave crests of the second structure portion is greater than 0.5 mm;
   the distance between the wave crests of the second structure portion is less than 10 mm;
   the wave crests of the first structure portion extend along the processing tracks;
   a geometry of the wave crests of the second structure portion varies in a longitudinal direction of the wave crests;
   an amplitude of the surface structure is between 0.005 mm and 0.25 mm.
21. The pneumatic tire according to one of embodiments 18 to 20,
   wherein an amplitude of the surface structure varies in a circumferential direction and wherein, starting from a location of maximum amplitude, the amplitude of the surface structure in the circumferential direction decreases continuously; and/or
   wherein the wave crests of the surface structure are arranged at least partially parallel to each other.
22. The pneumatic tire according to one of embodiments 18 to 21,
   wherein at least one boundary area of the bead base is free of the surface structure; and/or
   wherein in the processing region a recess is formed in the bead base.
23. A method for processing a pneumatic tire, in particular for thereby producing a pneumatic tire according to one of embodiments 1 to 22, wherein the pneumatic tire comprises a bead base, wherein the pneumatic tire defines an axial direction parallel to the rotational axis of the pneumatic tire and wherein the pneumatic tire defines a circumferential direction around the rotational axis, the method comprising:
   removing of tire material in a processing region of the bead base and thereby generating a protrusion extending toward the rotational axis and in the circumferential direction and wherein the protrusion has a geometry varying in the circumferential direction.
24. The method according to embodiment 23,
   wherein the protrusion extends over an angular range that is smaller than 360 degrees; and/or
   wherein the pneumatic tire during the removing of tire material is rotated about its rotational axis; and/or
   wherein in at least a part of the processing region tire material is removed multiple times.
25. The method according to embodiment 23 or 24,
   wherein the protrusion is a first protrusion and the removing of tire material in the processing region generates a second protrusion extending in the circumferential direction; and
   wherein the processing region is arranged between the first protrusion and the second protrusion and thereby defines a recess between the first protrusion and the second protrusion.
26. The method according to one of embodiments 23 to 25, wherein the recess in the axial direction and/or in the circumferential direction is trough-shaped.
27. The method according to one of embodiments 23 to 26, wherein the removing of tire material is performed up to a depth and the depth varies in the circumferential direction of the protrusion.
28. The method according to one of embodiments 23 to 27, wherein the processing region comprises a central region of the bead base and wherein the central region of the bead base in the axial direction is arranged between boundary areas of the bead base.
29. The method according to one of embodiments 23 to 28, wherein the removing of tire material is performed with laser radiation, in particular laser radiation of a CO2 laser.
30. The method according to embodiment 29, further comprising at least one of the following features:
   the CO2 laser is operated continuously during the removing;
   the CO2 laser has a Gaussian beam profile;
   the CO2 laser has an output power of more than 400 W, in particular an output power of more than 800 W.
31. The method according to one of embodiments 23 to 30, wherein the removing of the tire material is performed along at least one line.
32. The method according to embodiment 31, wherein the removing of the tire material is performed along a plurality of parallel lines;
   in particular wherein the parallel lines enclose with the axial direction an angle in a range between 0 degrees and 60 degrees or the parallel lines extend in the circumferential direction.
33. The method according to embodiment 32, wherein removal regions of neighboring lines overlap.
34. The method according to embodiment 33, further comprising one of the following features:
   an overlap of removal regions of neighboring lines is between 10% and 90%;
   an overlap of removal regions of neighboring lines is between 65% and 85%;
   an overlap of removal regions of neighboring lines is 10%, 20%, 33.333%, 50%, 66.667%, 80%, or 90%.
35. The method according to one of embodiments 33 or 34, wherein the overlap of removal regions of neighboring lines is constant.
36. The method according to one of embodiments 33 or 34, wherein the overlap of removal regions of neighboring lines is dependent on a depth of a removal generated by the removing.
37. The method according to one of embodiments 29 to 36, wherein during the removing of tire material in the processing region a power of the laser radiation is varied dependent on a position in the axial direction and/or dependent on a position in the circumferential direction.
38. The method according to one of embodiments 23 to 37, wherein during the removing of the tire material a rotation of the pneumatic tire about the rotational axis is performed, in particular a rotation at a constant angular speed.
39. The method according to embodiment 38, further comprising the features of embodiment 29 or embodiment 30, wherein the rotation of the pneumatic tire about the rotational axis is compensated for in a positioning of the laser radiation in the processing region.
40. The method according to one of embodiments 23 to 39,
   wherein at least one first holding finger is engaged with a first bead of the pneumatic tire and at least one second holding finger is engaged with a second bead of the pneumatic tire;
   wherein a distance between the first bead and the second bead is adjusted by a positioning of the at least one first holding finger and the at least one second holding finger relative to each other;
   wherein the rotating of the pneumatic tire during the removing of the tire material is performed by a driving of the at least one first holding finger into a rotational movement.
41. The method according to embodiment 40, wherein during the driving of the at least one first holding finger into a rotational movement, the second bead is in rolling engagement with the at least one second holding finger and the removing is performed on the second bead.
42. The method according to one of embodiments 40 or 41, wherein after the removing of tire material from the second bead, the removing of tire material from the first bead is performed;
   in particular wherein a rotating of the pneumatic tire during the removing from the first bead is performed by a driving of the at least one second holding finger into a rotational movement;
   in particular wherein the at least one second holding finger is in frictional engagement with the pneumatic tire during the driving into a rotational movement, in particular by a blocking of at least one roller of the at least one second holding finger.
43. The method according to embodiment 42, wherein during the driving of the at least one second holding finger into a rotational movement, the first bead is in rolling engagement with the at least one first holding finger.
44. The method according to one of embodiments 40 to 43, wherein the at least one first holding finger is engaged with the first bead of the pneumatic tire by moving the at least one first holding finger in a first transverse direction into the pneumatic tire and subsequently moving the at least one first holding finger in a direction towards the first bead.
45. The method according to one of embodiments 40 to 44, wherein the at least one second holding finger is engaged with the second bead of the pneumatic tire by moving the at least one second holding finger in a second transverse direction into the pneumatic tire and subsequently moving the at least one second holding finger in a direction towards the second bead.
46. The method according to embodiment 45,
   wherein the at least one first holding finger is mounted at a carrier; and
   the at least one first holding finger is moved in the first transverse direction into the pneumatic tire by lifting the carrier, wherein the carrier is arranged below a transport device.
47. The method according to embodiment 46,
   wherein for a driving of the at least one first holding finger into a rotational movement, the carrier is lifted over the transport device; and
   subsequently the carrier is driven into the rotational movement.
48. A tire processing machine for processing a pneumatic tire, in particular for thereby producing a pneumatic tire according to one of embodiments 1 to 22, wherein the pneumatic tire to be processed comprises a first bead and a second bead, wherein the pneumatic tire defines an axial direction parallel to a rotational axis of the pneumatic tire and wherein the pneumatic tire defines a circumferential direction around the rotational axis, the tire processing machine comprising:
   at least one first holding finger which is engageable with the first bead;
   at least one second holding finger which is engageable with the second bead;
   wherein the at least one first holding finger is operable to rotate the pneumatic tire, in particular together with the at least one first holding finger, with respect to the at least one second holding finger.
49. The tire processing machine according to embodiment 48, wherein the at least one second holding finger is operable to rotate the pneumatic tire together with the at least one second holding finger with respect to the at least one first holding finger.
50. The tire processing machine according to one of embodiments 48 or 49, wherein the at least one first holding finger and/or the at least one second holding finger is configured to hold the first bead and the second bead at a predetermined distance.
51. The tire processing machine according to one of embodiments 48 to 50,
   wherein the at least one first holding finger is configured for insertion of the at least one first holding finger into the pneumatic tire from a first side of the pneumatic tire;
   wherein the at least one second holding finger is configured for insertion of the at least one second holding finger into the pneumatic tire from a second side of the pneumatic tire, wherein the second side of the pneumatic tire is arranged opposite to the first side of the pneumatic tire.
52. The tire processing machine according to one of embodiments 48 to 51, further comprising a suction device.
53. The tire processing machine according to embodiment 52,
   wherein the suction device is bringable into a first position for suctioning process residues of a processing of the first bead; and/or
   wherein the suction device is bringable into a second position for suctioning process residues of a processing of the second bead.
54. The tire processing machine according to one of embodiments 52 or 53, wherein the tire processing machine comprises at least two of the first holding fingers and the suction device is positionable between two neighboring first holding fingers and/or wherein the tire processing machine comprises at least two of the second holding fingers and the suction device is positionable between two neighboring second holding fingers;
   in particular wherein a spatial position of the holding fingers, between which the suction device is positioned, remains unchanged during the processing.
55. The tire processing machine according to one of embodiments 48 to 54,
   further comprising a laser emitting device for emitting laser radiation onto the pneumatic tire for thereby processing the pneumatic tire;
   in particular wherein the laser emitting device is arranged radially outside the pneumatic tire;
   in particular wherein the laser emitting device comprises at least one scanner for moving a beam path of the laser radiation over the pneumatic tire, wherein in particular a scanning movement of the beam path comprises a directional component parallel to the axis of rotation.
56. The tire processing machine according to embodiment 55,
   wherein the laser emitting device is configurable for processing a bead base of the first bead; and/or
   wherein the laser emitting device is configurable for processing a bead base of the second bead; and/or
   wherein the laser emitting device is configurable for processing an inner surface of the pneumatic tire.
57. The tire processing machine according to one of the embodiments 48 to 56,
   further comprising a transport device on which the pneumatic tire is transportable in a lying manner;
   wherein the at least one first holding finger and the at least one second holding finger are engageable with the pneumatic tire lying on the transport device.
58. The tire processing machine according to embodiment 57, wherein the pneumatic tire is liftable by the at least one first holding finger and/or the at least one second holding finger from the transport device to a lifted position such that a sidewall of the pneumatic tire faces the transport device at a distance.
59. The tire processing machine according to embodiment 58 and further comprising the features of embodiment 55, wherein the laser emitting device is configured for processing the pneumatic tire in the lifted position.
60. The tire processing machine according to one of the embodiments 48 to 59,
   wherein the at least one first holding finger comprises a mechanical stop for a first surface portion of the first bead; and/or
   wherein the at least one second holding finger comprises a mechanical stop for a second surface portion of the second bead. 61. The tire processing machine according to one of the embodiments 48 to 60,
   wherein at least one of the at least one first holding finger comprises at least one first roller on which the first surface portion is rollable; and/or
   wherein at least one of the at least one second holding finger comprises at least one second roller on which the second surface portion is rollable.
62. The tire processing machine according to embodiment 61, further comprising at least one of the following features:
   on at least one of the at least one first roller, a lateral bead part of the first bead is rollable;
   on at least one of the at least one first roller, a bead base of the first bead is rollable;
   on at least one of the at least one second roller, a lateral bead part of the second bead is rollable;
   on at least one of the at least one second roller, a bead base of the second bead is rollable;
   at least one of the at least one first roller is blockable in its rotation for a frictional engagement of the pneumatic tire and the first roller;
   at least one of the at least one second roller is blockable in its rotation for a frictional engagement of the pneumatic tire and the second roller;
   at least one of the at least one first roller is drivable into a rotation for driving the pneumatic tire into a rotational movement;
   at least one of the at least one second roller is drivable into a rotation for driving the pneumatic tire into a rotational movement.
63. The tire processing machine according to one of embodiments 48 to 62, wherein the at least one first holding finger at a distance from the rotational axis is rotatable by at least 360 degrees about the rotational axis and/or the at least one second holding finger at a distance from the rotational axis is rotatable by at least 360 degrees about the rotational axis.
64. A method for operating a tire processing machine for processing a pneumatic tire, in particular for thereby producing a pneumatic tire according to one of embodiments 1 to 22, wherein the pneumatic tire to be processed comprises a first bead and a second bead, wherein the pneumatic tire defines an axial direction parallel to a rotational axis of the pneumatic tire and wherein the pneumatic tire defines a circumferential direction around the rotational axis, the method comprising:
   engaging at least one first holding finger with the first bead;
   engaging at least one second holding finger with the second bead;
   operating the at least one first holding finger, in particular into a rotational movement, to rotate the pneumatic tire, in particular together with the at least one first holding finger, with respect to the at least one second holding finger.
65. A wheel comprising a rim and a pneumatic tire according to one of embodiments 1 to 22 mounted on the rim.
66. The wheel according to embodiment 65, wherein the protrusion of the bead base is deformed by the rim; in particular wherein due to the rim the protrusion of the bead base comprises a circumferentially varying deformation.
67. A control device configured to perform a method according to at least one of embodiments 23 to 47 and/or a method according to embodiment 64.
68. A computer program product comprising a program element configured to, when executed on a processor device, perform a method according to at least one of embodiments 23 to 47 and/or a method according to embodiment 64.

Further features and advantages of the present disclosure will become apparent from the following exemplary description of exemplary implementations of presently preferred embodiments, to which the claimed invention is not limited, however. The individual figures of the drawings of this document are to be regarded merely as schematic and not to scale.

### BRIEF DESCRIPTION OF THE DRAWINGS

FIG. 1 shows, in a cross-sectional view, a part of a wheel according to embodiments of the herein disclosed subject matter.

FIG. 2 shows, in an enlarged representation, a part of the first bead of FIG. 1.

FIG. 3 shows, in a partial representation, a further (first) bead according to embodiments of the herein disclosed subject matter.

FIG. 4 shows, schematically, a side view of the pneumatic tire of FIG. 1.

FIG. 5 shows a plan view of a bead base according to embodiments of the herein disclosed subject matter.

FIG. 6 shows, schematically, a cross-sectional view of a surface structure of a processing region of the bead base of FIG. 5, according to embodiments of the herein disclosed subject matter.

FIG. 7 shows a plan view of a part of a processing region of a further bead base according to embodiments of the herein disclosed subject matter.

FIG. 8 shows a plan view of a part of a processing region of a further bead base according to embodiments of the herein disclosed subject matter.

FIG. 9 illustrates an embodiment of a method for generating parallel lines according to embodiments of the herein disclosed subject matter.

FIG. 10 shows a tire processing machine according to embodiments of the herein disclosed subject matter.

FIG. 11 shows the tire processing machine of FIG. 10, wherein the at least one first holding finger and the at least one second holding finger are located in the radially outer position.

FIG. 12 shows a further tire processing machine according to embodiments of the herein disclosed subject matter.

FIG. 13 shows the tire processing machine of FIG. 12 in a further state.

FIG. 14 shows the tire processing machine of FIGS. 12 and 13 with the pneumatic tire in a position lifted from the transport device.

FIG. 15 shows a further tire processing machine according to embodiments of the herein disclosed subject matter.

FIG. 16 shows the tire processing machine of FIG. 15 in a side view, as seen from line XIII-XIII in FIG. 15.

FIG. 17 shows the tire processing machine of FIGS. 15 and 16 with further details for explaining further embodiments of the herein disclosed subject matter.

FIG. 18 shows a part of the tire processing machine of FIG. 17 in a side view.

FIG. 19 shows the tire processing machine in the illustration of FIG. 18 during the processing of the bead base of the second bead 112.

### DETAILED DESCRIPTION

It is noted that in different figures, similar or identical elements or components are provided with the same reference numerals, or with reference numerals which only have a 2 or a 3 instead of a 1 or a 5 or a 6 instead of a 4 in the first digit. Such features or components which are identical or at least functionally identical with the corresponding features or components in another figure are described in detail in the following text only upon their first occurrence and the description is not repeated upon the subsequent occurrence of these features and components (or the corresponding reference numerals).

It is understood that an exemplary implementation of the elements described below and provided with reference numerals is represented in the respective drawings and configured according to the corresponding description, unless otherwise specified.

Furthermore, it is to be noted that embodiments which are described in the context of an exemplary implementation (i.e. an exemplary combination of embodiments) with reference to a particular drawing are not limited to this implementation. Rather, as already explained above, the embodiments described herein are arbitrarily combinable. Thus, embodiments which are described with reference to different implementations in different drawings are also combinable with one another.

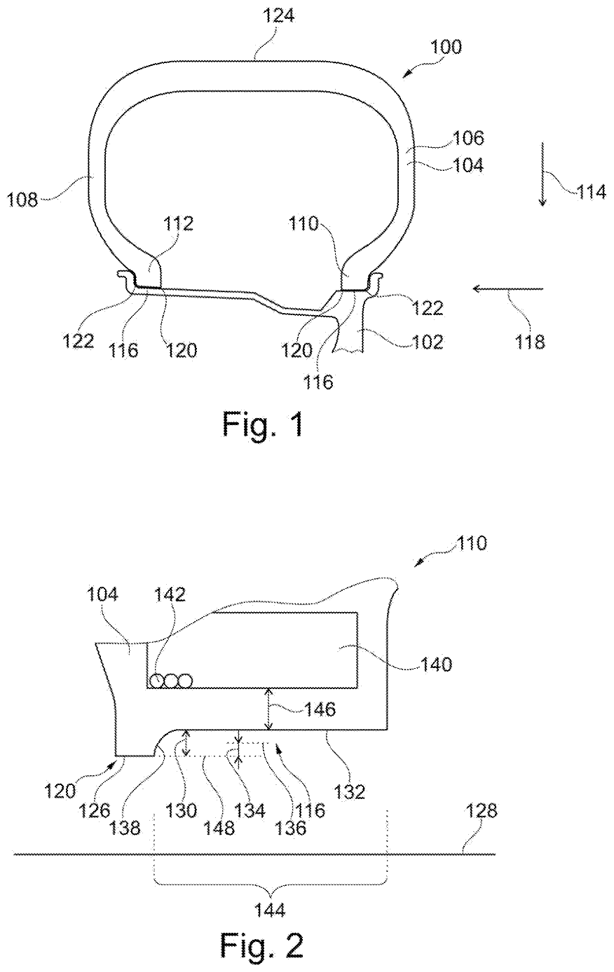

FIG. 1 shows, in a cross-sectional view, a part of a wheel 100 according to embodiments of the herein disclosed subject matter.

According to an embodiment, the wheel 100 comprises a rim 102 and a pneumatic tire 104 according to embodiments of the herein disclosed subject matter mounted on the rim. According to an embodiment, the pneumatic tire 104 comprises a first sidewall 106 and a second sidewall 108, which faces away from the first sidewall 106.

The pneumatic tire 104 further comprises a first bead 110 and a second bead 112. In a radial direction 114, the pneumatic tire 104 rests with a bead base 116 of the respective bead 110, 112 on the rim 102. The bead base 116 further comprises, as seen in an axial direction 118, a first boundary area 120 which faces an interior of the pneumatic tire 104 and is also referred to herein as the bead toe in. Further, the bead base 116 comprises a second boundary area 122 which is arranged opposite to the first boundary area 120 in the axial direction 118 and is also referred to herein as the bead heel. The bead base 116 extends in a circumferential direction of the tire. In this regard, in an embodiment, the bead base 116 also defines a circumferential direction of the tire (perpendicular to the plane of the drawing, not illustrated in FIG. 1). According to an embodiment, the bead base has a protrusion extending in the circumferential direction (not illustrated in FIG. 1), wherein the protrusion has a geometry varying in the circumferential direction and comprises a circumferentially varying deformation in the circumferential direction due to the contact with the rim 102.

A tread surface 124 of the pneumatic tire 104 is arranged between the first sidewall 106 and the second sidewall 108.

FIG. 2 shows, in an enlarged representation, a part of the first bead 110 of FIG. 1.

According to an embodiment, the bead base 116 has a protrusion 126 extending toward a rotational axis and in the circumferential direction of the bead base, for example as illustrated in FIG. 2. The rotational axis is illustrated schematically at 128 in FIG. 2, wherein the dimensions and in particular the distance between the bead base 116 and the rotational axis 128 are not to scale.

According to an embodiment, the protrusion 126 has a geometry varying in the circumferential direction. For example, a height 130 of the protrusion with respect to a bottom 132 of the bead base can vary in the circumferential direction in the circumferential direction. For example, from a first height (for example the height 130) to a second height 134. A level of the bottom 132 of the bead base at the second height 134 is indicated by dashed lines at 136 in FIG. 2. According to an embodiment, the protrusion 126 is arranged in the first (inner) axial boundary area 120, for example as illustrated in FIG. 2.

According to an embodiment, a shape of a transition 138 from the protrusion 126 to the bottom 132 of the bead base 116 varies in the circumferential direction.

According to an embodiment, the bead 110 has a bead core 140. As is known to those skilled in the art, the bead core is formed, for example, by an annular steel wire or by a plurality of annular strands, for example steel, some of which are indicated by way of example at 142 in FIG. 2.

According to an embodiment, the protrusion 126 is generated by removal of tire material in a processing region 144 of the bead base 116. In this way, a distance 146 of the bottom 132 of the bead base 116 from the bead core 140 is reduced by the removal. According to an embodiment, the level of the original bottom 148 of the bead base corresponds to the level of the protrusion 126, for example as illustrated in FIG. 2. The term level refers herein to a level with respect to the axis of rotation of the tire unless expressly stated otherwise.

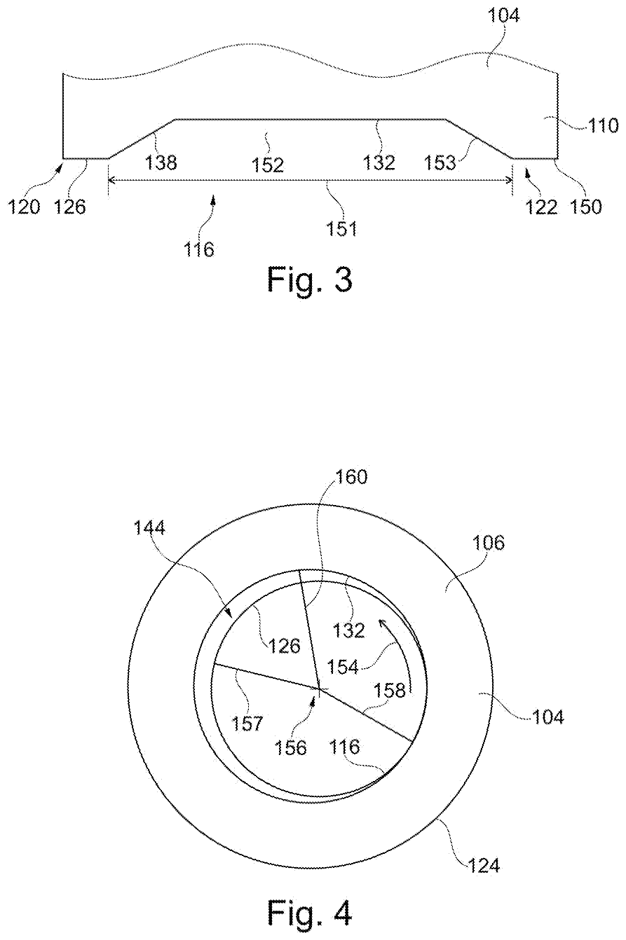

FIG. 3 shows, in a partial representation, a further (first) bead 110 according to embodiments of the herein disclosed subject matter.

According to an embodiment, the bead base 116 comprises a second protrusion 150 at an axial distance 151 from the first protrusion 126. According to an embodiment, the first protrusion 126 and the second protrusion 150 define between them a recess 152 which is generally trough-shaped. According to an embodiment, the transition 138, 153 between the bottom 132 and the respective protrusion 126, 150 can run, for example, substantially rectilinearly, for example as illustrated in FIG. 3. In this case, the trough-shaped recess 152 in the axial cross section can have a trapezoidal shape, for example as illustrated in FIG. 3. According to an embodiment, the first protrusion 126 is arranged in the region of the bead toe 120 and the second protrusion 150 is arranged in the region of the bead heel 122, for example as illustrated in FIG. 3. The arranging of the protrusions 126, 150 in opposite, axial boundary areas 120, 122 of the bead base 116, as illustrated by way of example in FIG. 3, has the advantage that a compressive load on the bead base is distributed more uniformly than in the case of only one protrusion (for example the protrusion 126, as illustrated in FIG. 2).

FIG. 4 shows, schematically, a side view of the pneumatic tire 104 of FIG. 1.

For reasons of clarity, the rim 102 is not illustrated in FIG. 4. According to an embodiment, the protrusion 126 extends in the circumferential direction 154 over an angular range which is smaller than 360 degrees. In other words, in one embodiment the protrusion 126 does not extend over the entire circumference of the bead base 116. According to an embodiment, the removal is performed continuously in the circumferential direction 154, i.e. a depth of the removal (to which, according to an embodiment, the height 130 of the protrusion 126 corresponds, see FIG. 2) varies continuously in the circumferential direction 154, for example as illustrated in FIG. 4.

As a result of the removal of rubber material (tire material), a distance of the bottom 132 of the bead base 116 from the axis of rotation 156 changes, which corresponds to improved concentricity of the pneumatic tire 104. According to an embodiment, the unprocessed bead base 116, the radial level of which is given by the protrusion 126 according to an embodiment, does not run concentrically about the axis of rotation 156, for example as illustrated schematically in FIG. 4. In other words, according to an embodiment, a first distance 157 of the unprocessed bead base from the axis of rotation 156 is different from a second distance 158 of the unprocessed bead base from the axis of rotation 156, for example as illustrated in FIG. 4. As a result of the removing of tire material in the processing region 144 of the bead base 116, according to an embodiment the bottom of the bead base 116 is brought to an equidistant distance 160 (or anyway approximated to the distance 158) from the axis of rotation 156. In this way, the concentricity of the tire can be improved.

It is understood that the concentricity or the improved concentricity of a tire always applies to the tire mounted on a rim. Thus, the bottom 132 of the bead base 116 is also decisive for the concentricity, whereas the protrusion 126 according to an embodiment is deformed during the mounting on the tire.

It should be understood that FIG. 4 merely illustrates a simple case of a concentricity correction of a pneumatic tire and that, according to an embodiment, deviations of a higher order can also be corrected by the removing of tire material. As a result, the height of a protrusion (for example the height 138 of the protrusion 126, see FIG. 2) in the circumferential direction can have local maxima and/or local minima (not illustrated). Consequently, the geometry of the protrusion or the geometry of the bottom of the bead base 132 or the geometry of the recess 152 in the circumferential direction can have local maxima and/or local minima. Of course, however, these geometrical deviations are to be distinguished from a surface structure in the processing region which has been generated by removal of tire material along processing tracks in the processing region.

Exemplary embodiments for the removing of tire material (i.e. for carrying out the removal) are explained below.

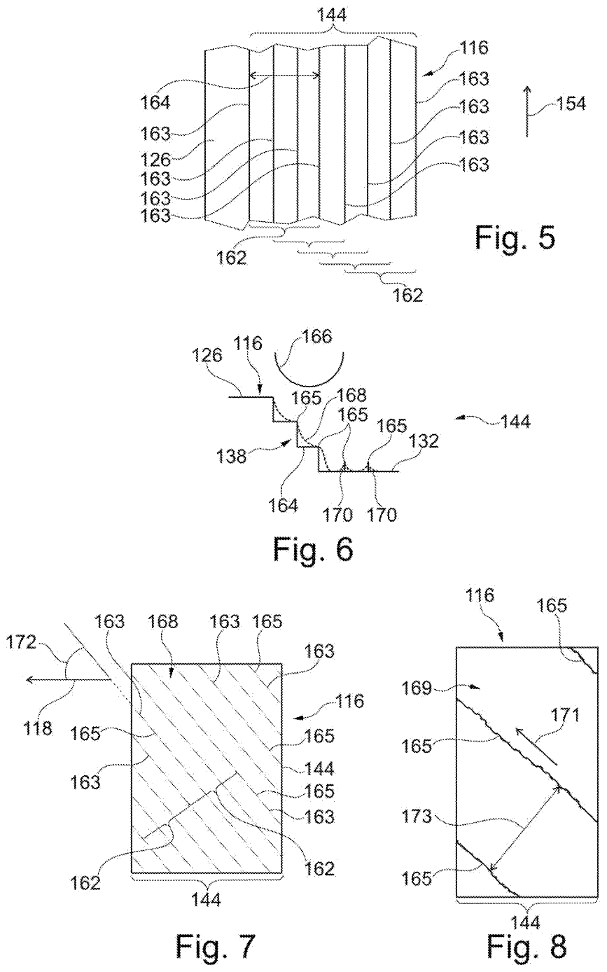

FIG. 5 shows a plan view of a bead base 116 according to embodiments of the herein disclosed subject matter.

According to an embodiment, the processing region 144, in which tire material has been removed, extends next to the protrusion 126. According to an embodiment, the removal is performed with laser radiation, in particular laser radiation of a CO2 laser. According to an embodiment, the removal of tire material in the processing region 144 is performed along parallel lines (in FIG. 5, some of the parallel lines or the extent thereof in a transverse direction, perpendicular to the longitudinal direction of the lines, are indicated at 162). According to an embodiment according to an embodiment, removal regions 162 of the parallel lines overlap, for example the removal regions 162 overlap over two thirds of their line width 164, for example as illustrated in FIG. 5. The removal of tire material along a line removes tire material in the removal region 162 and thereby generates, according to an embodiment, a processing track in the sense of the present disclosure. According to an embodiment, the processing track is thus defined by the removal region in which the tire material is removed. Thus, according to an embodiment, the terms “removal region” and “processing track” used herein are interchangeable with one another. It goes without saying that, in the case of overlapping removal regions, the removal region 162 can be removed at least partially by the subsequent removal in the overlapping removal regions and is thus no longer visible on the final pneumatic tire 104.

According to an embodiment, the removal regions 162 of the parallel lines extend in the circumferential direction 154, i.e. the longitudinal direction of the lines is parallel to the circumferential direction 154, for example as illustrated in FIG. 5.

According to an embodiment, the removal regions 162 of the parallel lines (i.e. the processing tracks) have a defined extent transversely with respect to the longitudinal direction and thus define an edge 163 of the respective removal region/processing track 162.

FIG. 6 shows, schematically, a cross-sectional view of a surface structure 168 of a processing region 144 of the bead base of FIG. 5, according to embodiments of the herein disclosed subject matter.

According to an embodiment, the transition region 138 between the protrusion 126 and the bottom 132 of the bead base 116 comprises different numbers of overlapping removal regions 132, for example as described with reference to FIG. 5. In this way, in a direction transversely with respect to the parallel lines, in the transition region 138 between the protrusion 126 and the bottom 132 a stepped surface structure is resulting, which illustrated schematically and idealized at 164 in FIG. 6. It is understood that removal by the laser radiation will never be ideally geometric, but that deviations from an ideal geometric shape are resulting. This applies all the more if, according to an embodiment, the laser radiation has a Gaussian intensity profile over its beam cross section, as is indicated schematically at 166 in FIG. 6. In this way, in any case with suitable process control, instead of the stepped surface profile an undulated surface structure 168 is generated, as is indicated in a dashed line in FIG. 6.

According to an embodiment, a surface structure 168 is also generated on the bottom 132 of the bead base by the overlapping removal regions 162 and/or by the edges 163 or boundary areas of the removal regions 162. For example, according to an embodiment, non-removed rubber material 170 on the edge 163 of the removal regions 162 is is left on the bottom 132 of the processing region 144 (i.e. on the bottom of the bead base). The rubber material 170 also provides according to an embodiment, for example due to the Gaussian intensity profile 166 of the laser radiation, a undulated surface structure 168 on the bottom 132, wherein the wave crests 165 can have a pointed shape in this case. A surface structure whose wave crests 165 have a pitch distance (distance of the peak tips of the wave crests) that is equal to or smaller than the width 164 of the removal regions 162, such as the surface structure 168 described with reference to FIGS. 5 and 6, is also referred to herein as first structure portion). According to an embodiment, the surface structure 168 (in particular the first structure portion of the surface structure) is defined by edges of the processing tracks or edges 163 of the removal regions 162 of parallel lines. Consequently, according to an embodiment, the position of the edges 163 corresponds to the position of wave crests of the surface structure, some of which are indicated at 165 in FIG. 6.

FIG. 7 shows a plan view of a part of a processing region 144 of a further bead base 116 according to embodiments of the herein disclosed subject matter.

According to an embodiment, in the processing region 144 of the bead base 116 tire material was removed along a plurality of parallel, overlapping lines, wherein the removal regions 162 of the lines or their edges illustrated in FIG. 7, some of which are denoted by 163, enclose an angle 172 in a range between 0 degrees and 60 degrees with the axial direction 118, for example an angle of approximately 50 degrees, for example as illustrated in FIG. 7. Otherwise, the illustrated overlap of the removal regions 162 is analogous to the illustration in FIG. 5.

As explained above with reference to FIG. 6, in an embodiment the edges 163 of the processing tracks or of the removal regions 162 define the wave crests 165 of the surface structure 168, as illustrated schematically in FIG. 7. Consequently, in an embodiment, the wave crests 165 of the surface structure 168 extend at the angle 172 to the axial direction 118. The machining transverse with respect to the axial direction 118 (i.e. the angle 172 is between 5 degrees and 60 degrees, for example) has the advantage that, for a given width of the processing region 144 in the axial direction, a longitudinal extent of the individual processing tracks or removal regions 162 is greater than the width of the removal region 144 in the axial direction. In this way, by adjusting the angle 172, the longitudinal extent of the removal regions 162 can be adapted to an available scanning path of a laser scanner, so that the longitudinal extent of the removal regions 162 is as long as possible, but not longer than a maximum scanning path of the laser scanner. In this way, the efficiency of the removal can be increased.

FIG. 8 shows a plan view of a part of a processing region 144 of a further bead base 116 according to embodiments of the herein disclosed subject matter.

According to an embodiment, a surface structure comprises a structure portion (also referred to herein as second structure portion 169) whose wave crests 165 have a distance 173 that is greater than a width of the removal regions 162 or of the processing tracks, wherein also the second structure portion is generated according to an embodiment by the removal of tire material along the removal regions of lines (or processing tracks) according to the embodiments disclosed herein, in particular by removal regions 162 as described with reference to FIGS. 5, 6 and 7. In particular, the wave crests 165 of the second structure portion 169 are generated in an embodiment such that they do not run completely parallel to each other and, according to a further embodiment, also not completely rectilinearly. Therefore, according to an embodiment, the distance 173 of the wave crests 165 of the second structure portion 169 is specified according to an embodiment as the average distance of the wave crests 165 of the second structure portion 169. Furthermore, according to an embodiment, an amplitude of the wave crests 165 of the second structure portion 169 can vary in a longitudinal direction 171 of the wave crests 165 of the second structure portion 169. According to an embodiment, the wave crests 165 of the second structure portion 169 extend in the longitudinal direction 171 of the wave crests 165 only over a part of the processing region 144.

According to an embodiment, the pneumatic tire 104 is rotated about its rotational axis during the processing of the processing region 144. In order to generate in this case parallel lines or parallel processing tracks, the rotation of the pneumatic tire is compensated for by a suitable guiding of the beam path of the laser radiation.

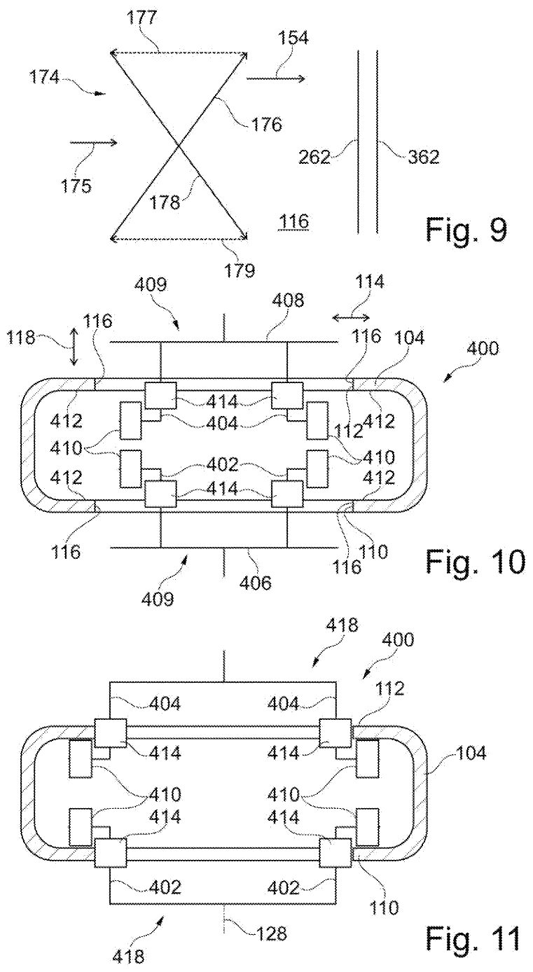

FIG. 9 illustrates an embodiment of a method for generating parallel lines according to embodiments of the herein disclosed subject matter.

FIG. 9 shows an embodiment of a path 174 of the beam path on the bead base 116, wherein the bead base 116 moves at a speed 175 in the circumferential direction 154. The path 174 of the beam path on the bead base corresponds to the path of the laser spot generated by the laser radiation on the bead base if laser radiation is emitted. Since, according to an embodiment, the laser radiation is switched off in some path sections, however, only the path of the beam path on the bead base is referred to below. According to an embodiment, starting from a first starting point, the path 174 encompasses a first path section 176, in which the beam path of the laser radiation is moved with a directional component in the circumferential direction 154. This movement of the beam path along the path 174 on the bead base 116 is performed, for example, by means of a laser scanner. According to an embodiment, at the end of the first path section (for example at the edge of the processing region or at the end of the scanning path of the laser scanner), the laser radiation is switched off and the beam path is guided back counter to the circumferential direction 154 on a second path section 177 to a second starting point (also referred to herein as back jump), from which, according to an embodiment, the beam path is again moved along a third path section 178 with a directional component in the circumferential direction 154. At the end of the third path section, according to an embodiment, a further back jump to the first starting point is performed along a fourth path section 179, again with switched-off laser radiation. In this way, the first path section 176 generates on the bead base a first removal region 262 and the second path section 178 generates a second removal region 362 (symbolized by lines in FIG. 9), which, with suitable tuning of the speeds (speed of the beam path of the laser radiation lengthwise the first path section 176 and the third path section 178 as well as the speed 175 of the bead base 116) run parallel, for example with a longitudinal direction perpendicular to the circumferential direction 154. In this case, the time duration for the back jump (path sections 177 and 179) and the speed 175 determine the distance of the parallel removal regions 262, 362.

FIG. 10 shows a tire processing machine 400 according to embodiments of the herein disclosed subject matter.

The tire processing machine comprises at least one first holding finger 402, for example two first holding fingers 402, for example as illustrated in FIG. 10. According to an embodiment, the tire processing machine 400 comprises at least one second holding finger 404, for example two first holding fingers 404, for example as illustrated in FIG. 10. According to an embodiment, the at least one first holding finger is operable to rotate the pneumatic tire 104 together with the at least one first holding finger 402 with respect to the at least one second holding finger 404.

According to an embodiment, the at least one first holding finger 402 is mounted on a first carrier 406 and the at least one second holding finger 404 is mounted on a second carrier 408. According to an embodiment, the at least one first holding finger 402 and the at least one second holding finger 404 are movable in a transverse direction, for example in the axial direction 118 into (and out of) the pneumatic tire 104. For example, the at least one first holding finger 402 and the at least one second holding finger 404 are movable with respect to their carrier 406, 408 in the radial direction 114, in particular movable into a radially inner position 409, for example as illustrated in FIG. 10.

According to an embodiment, the at least one first holding finger 402 and the at least one second holding finger 404 are movable with respect to their carrier 406, 408 into a radially outer position (not illustrated in FIG. 10), in which the at least one first holding finger 402 is engaged with the first bead 110 and in which the at least one second holding finger 404 is engaged with the second bead 112.

According to a further embodiment, the at least one holding finger 402 and the at least one holding finger 404 each comprise at least one roller that can be configured such that it is rollable on a surface of the pneumatic tire 104. For example, each holding finger 402, 404 can comprise a first roller 410 and/or a second roller 414 as described below. In other embodiments (not illustrated), instead of a rolling engagement (by the provision of the first and/or the second roller), a sliding engagement of at least one holding finger is also possible. However, a rolling engagement can be more gentle and thereby protect the surface of the pneumatic tire.

For example, the at least one roller comprises a first roller 410, which is rollable or configurable on a bead inner surface 412 of the pneumatic tire in order to roll on the bead inner surface 412 of the pneumatic tire. According to an embodiment, the bead inner surface 412 faces axially inwards and is arranged neighboring to the bead base 116, for example as illustrated in FIG. 10.

According to a further embodiment, the at least one roller of each holding finger 402, 404 comprises a second roller 414, which is rollable on the associated bead base 116 of the pneumatic tire 104 or, respectively, is configurable to roll on the bead base 116.

According to an embodiment, at least one first roller 410 and/or at least one second roller 414 is configurable in order to allow or block a rotation of the respective roller about its axis (also referred to herein as “roller axis”).

FIG. 11 shows the tire processing machine 400 of FIG. 10, wherein the at least one first holding finger 402 and the at least one second holding finger 404 are located in the radially outer position 418. The radially outer position 418 is also referred to herein as engagement position, since in this position the respective holding finger is engaged with the pneumatic tire 104.

According to an embodiment, the rollers 410, 414 of the at least one first holding finger 402 are in its radially outer position 418 in engagement with the first bead 110 of the pneumatic tire 104, for example as illustrated in FIG. 11. According to a further embodiment, the rollers 410, 414 of the at least one second holding finger 404 are in its radially outer position 418 in engagement with the second bead 112 of the pneumatic tire 104, for example as illustrated in FIG. 11.

According to an embodiment, the at least one first holding finger 402 is operable to rotate the pneumatic tire 104 together with the at least one first holding finger 402 with respect to the at least one second holding finger 404. For example, according to an embodiment, the first rollers 410 and/or the second rollers 414 of the at least one first holding finger 402 are configured to come into frictional engagement with the first bead 110. For example, for this purpose, the first rollers 410 and/or the second rollers 414 are configured to establish a frictional engagement in order to block a rotation about their axis.

According to an embodiment, the first rollers 410 and the second rollers 414 of the second holding finger 404 are configured to allow a rotation of the first rollers 410 and the second rollers 414 of the second holding finger 404. In this way, during the rotation of the pneumatic tire 104 about its rotational axis 128, the second bead 112 can roll on the first rollers 410 (and according to an embodiment also on the second rollers 414), so that the second bead 112 is held at a predetermined distance from the first bead 110 and nevertheless the second bead 112 is rotatable with respect to the second holding fingers 404, in particular is freely rotatable. In this way, precise processing of the second bead 112 is enabled.

As described herein, according to a further embodiment, processing of the first bead is enabled by configuring the first rollers 410 and the second rollers 414 of the first holding fingers 402 in order to allow a rotation about their roller axis, while configuring the first rollers 410 and the second rollers 414 of the second holding fingers 404 in order to block a rotation and thereby bring the second holding fingers 404 into frictional engagement with the second bead 112. This configuration of the rollers 410, 414 thus allows, via a rotational movement of the second holding fingers 404 about the rotational axis 128, also to drive the pneumatic tire 104 into a rotational movement about the rotational axis 128, while the first bead 110 rolls on the rollers 410, 414 of the at least one first holding finger 402. In this way, precise processing of the first bead can be enabled.

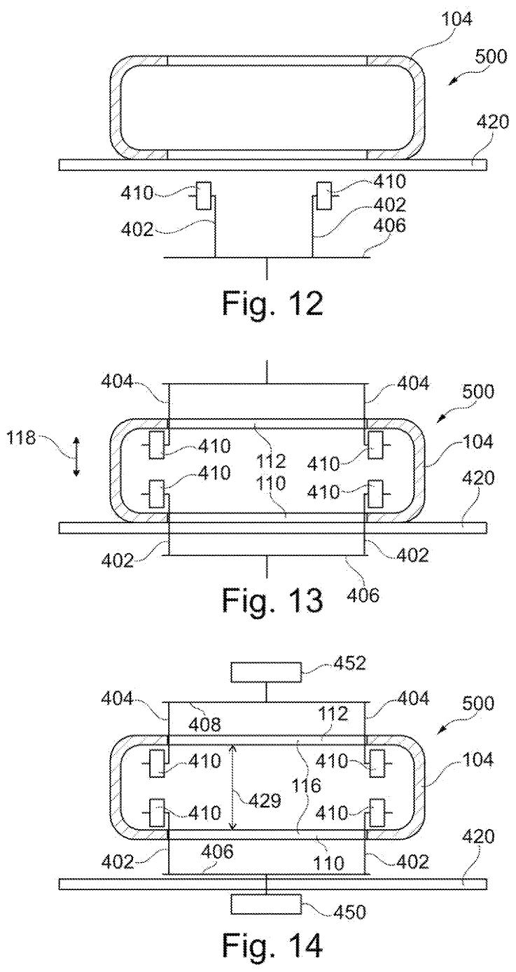

FIG. 12 shows a further tire processing machine 500 according to embodiments of the herein disclosed subject matter.

According to an embodiment, the tire processing machine 500 comprises a carrier 406 at which at least two first holding fingers 402 are mounted, for example as illustrated in FIG. 12. It is understood that more than two first holding fingers 402 may be mounted at the carrier 406, for example four or more first holding fingers 402. For reasons of simpler illustration and clarity, however, only two first holding fingers are illustrated in FIG. 12.

According to an embodiment, each of the at least two first holding fingers 402 comprises a roller 410 (also referred to herein as first roller), for example a first roller 410 as described with reference to FIGS. 10 and 11.

According to an embodiment, the carrier 406 with the first holding fingers 402 and the first rollers 410 is arrangeable below a transport device 420, for example as illustrated in FIG. 12. In this position of the carrier and of the first holding fingers 402, a conveying of the pneumatic tire 104 into the tire processing machine 500 is possible in a simple manner.

FIG. 13 shows the tire processing machine 500 of FIG. 12 in a further state.

According to an embodiment, the first holding fingers 402 are engaged with a first bead 110 and at least two second holding fingers 404 are engaged with a second bead 112 of the pneumatic tire 104. According to an embodiment, an engaging of the first and second holding fingers 402, 404 with the associated bead 110, 112 can be performed by an engagement of the rollers 410 with the associated first bead 110 or the second bead 112, for example as illustrated in FIG. 13. According to an embodiment, the first holding fingers 402 engage through the transport device 420, for example as illustrated in FIG. 13. According to an embodiment, to this end the transport device may have transport sections which are spaced apart from one another and between which the first carrier 106 and the first holding fingers 402 can pass. According to an embodiment, the first bead 110 and the second bead 112 are held at a defined distance from one another by the at least two first holding fingers 402 and the at least two second holding fingers 404. According to an embodiment, the at least two first holding fingers 402 and the at least two second holding fingers 404 are movable together, for example in the axial direction 118, for example as illustrated in FIG. 13. According to an embodiment, in this case the distance of the first bead 110 and the second bead 112 from one another remains constant and at any rate adopts the defined distance in an end position (e.g. a lifted position as described with reference to FIG. 14).

FIG. 14 shows the tire processing machine 500 of FIGS. 12 and 13 with the pneumatic tire 104 in a position lifted from the transport device 420.

According to an embodiment, the first carrier 406 is configured to be positionable over the transport device 420, for example as illustrated in FIG. 14. In this way, according to an embodiment, the first carrier 406 together with the first holding fingers 402 is freely rotatable in the lifted position.

According to an embodiment, at least in the lifted position, the distance 429 of the first bead 110 and the second bead 112 from one another has a defined (predetermined) value. This allows precise processing of the bead base, in particular since an orientation and/or a position of the bead base 116 can change during a deformation of the pneumatic tire.

According to an embodiment, the tire processing machine 500 comprises a first drive device 450, which is configured to drive the first carrier 406 together with the first holding fingers 402 into a rotational movement to thereby rotate the pneumatic tire 104, when the rollers 410 of the first holding fingers 402 are configured for a frictional engagement with the pneumatic tire 104.

According to a further embodiment, the tire processing machine 500 comprises a second drive device 452, which is configurable to drive the second carrier 408 together with the second holding fingers 404 into a rotational movement to thereby rotate the pneumatic tire 104, when the rollers 410 of the second holding fingers 404 are configured for a frictional engagement with the pneumatic tire 104.

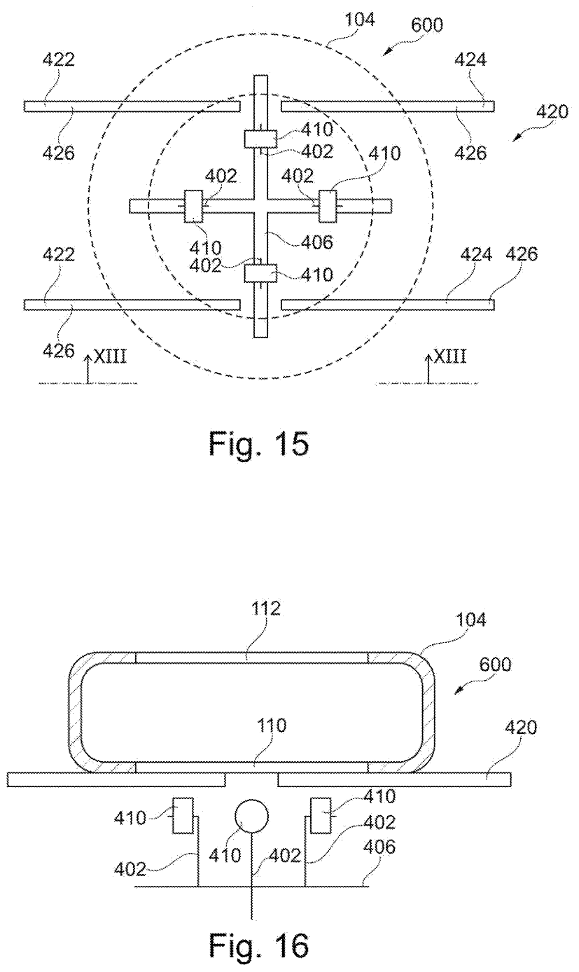

FIG. 15 shows a further tire processing machine 600 according to embodiments of the herein disclosed subject matter.

According to an embodiment, the tire processing machine 600 comprises a transport device 420, which comprises a first transport section 422 and a second transport section 424, which are arranged at a distance from one another, for example as illustrated in FIG. 15. According to an embodiment, between the first transport section 422 and the second transport section 424, a first carrier 406 is arranged, on which four first holding fingers 402 are mounted, which each comprise a roller, in particular a first roller 410 as described in particular with reference to FIGS. 10 to 14.

The transport sections 422 and 424 may be formed, for example, by two belt sections 426 of a conveyor belt arranged at a distance from one another, for example as illustrated in FIG. 15.

According to an embodiment, the transport device 420 is configured to transport the pneumatic tire 104 in a lying manner, i.e. the pneumatic tire 104 rests with one of its two sidewalls on the transport device 420, for example as illustrated in dashed lines in FIG. 15.

FIG. 16 shows the tire processing machine 600 of FIG. 15 in a side view, as seen from line XIII-XIII in FIG. 15.

According to an embodiment, the first carrier 406 is arranged in a first position below the transport device 420, for example as illustrated in FIG. 15. In this way, the pneumatic tire 104 can be conveyed into the tire processing machine 501 without there being a risk of a collision with the at least one first holding finger 402 or its roller 410.

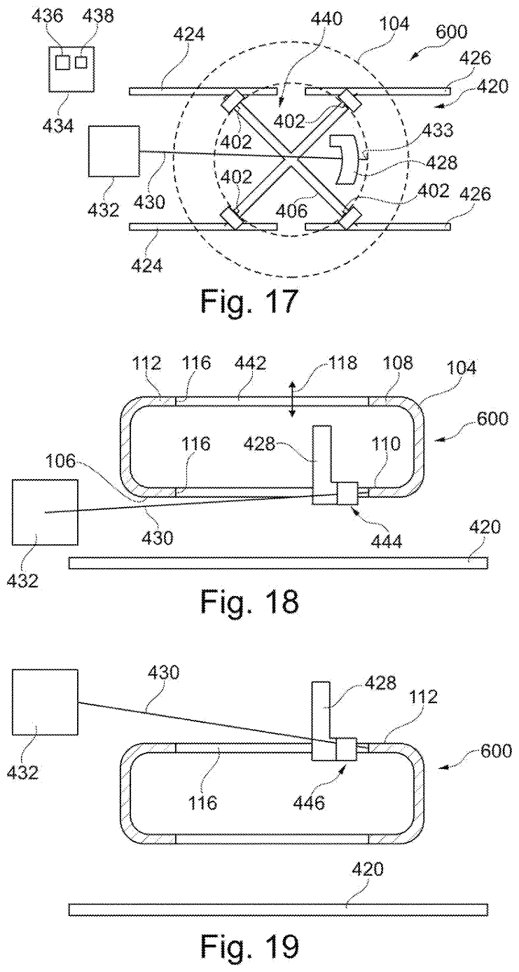

FIG. 17 shows the tire processing machine 600 of FIGS. 15 and 16 with further details for explaining further embodiments of the herein disclosed subject matter.

According to an embodiment, the carrier 406 is lifted in a second position over the transport device 420, into the pneumatic tire 104, in order to engage the first holding fingers 402 with the pneumatic tire 104, for example as illustrated in FIG. 17. According to a further embodiment, the tire processing machine 600 can comprise a suction device 428. According to an embodiment, the transport device is arranged opposite to a first sidewall of the pneumatic tire 104 and the suction device 428 is positioned into the pneumatic tire from an opposite side, which faces the second sidewall of the pneumatic tire 104, such that the suction device faces the processing location 433 to be processed (in particular in the processing region 144 on the bead base 116) of the pneumatic tire 104, for example as illustrated in FIG. 17.

According to an embodiment, the tire processing machine 600 is configured to process the pneumatic tire 104 with a laser radiation 430. For example, the tire processing machine 600 comprises according to an embodiment a laser emitting device 432 from which laser radiation 430 is emittable. According to an embodiment, the suction device 428 is configured to allow the laser radiation 430 to pass through the suction device 428. In this way, the suction device 428 can be positioned very close to the processing location 433 of the pneumatic tire 104, which is processed with the laser radiation 430.

According to an embodiment, the laser processing device 600 comprises a control device 434, which is configured to control components of the laser processing machine 600, for example the laser emitting device 432, the transport device 420 or the carrier 406 or drive devices 450, 452 and/or actuators, which are associated with the carrier 406 and allow a movement of the carrier according to the embodiments disclosed herein.

According to an embodiment, the control device comprises a processor device 436 and a memory device 438, in which a computer program product is stored according to an embodiment, for example a program element configured to, when executed on the processor device 436, perform a method according to one or more of the embodiments disclosed herein and in particular to control the laser processing machine 600.

According to an embodiment, the first carrier 406 is brought into a processing position 440 before the processing of the first bead with the laser radiation 430 and is fixed in this processing position 440 during the processing of the first bead.

According to an embodiment, the processing position 440 of the first carrier 406 is rotated with respect to a run-in position for running-in into the pneumatic tire 104, which is illustrated in FIG. 15, for example by 45 degrees, for example as illustrated in FIG. 17. For example, according to an embodiment, the first carrier 406 is brought into the processing position 440 together with the first holding fingers 402 in order to allow or facilitate a positioning of the suction device 428 with respect to the first bead and the laser radiation 430 on the first bead 110.

FIG. 18 shows a part of the tire processing machine 600 of FIG. 17 in a side view.

In FIG. 18, the holding fingers are not illustrated in order to facilitate the illustration of the laser radiation 430 or of the beam path thereof. According to an embodiment, the laser emitting device 432 is configured (for example formed and arranged) to guide the laser radiation 430 at a distance via the first sidewall 106 onto the bead base 116 of the first bead 110, for example as illustrated in FIG. 18, in order to process the bead base 116 of the first bead.

According to an embodiment, the suction device 428 has a parking position (not illustrated in FIG. 18), which faces the second sidewall 108 of the pneumatic tire 104, such that the suction device 428 according to an embodiment can be brought in the axial direction 118 through an opening 442, which is defined by the bead base 116 of the second bead, into a suction position, for example a first suction position 444, for example as illustrated in FIG. 18. According to an embodiment, in the first suction position 444 the beam path of the laser radiation 430 extends, during a processing of the bead base 116 of the first bead 110, through the suction device 428, for example as illustrated in FIG. 18.

It is understood that the suction device is connected during operation is connected via a suction channel (not illustrated in FIG. 18) to a negative pressure source (not illustrated in FIG. 18).

FIG. 19 shows the tire processing machine 600 in the illustration of FIG. 18 during the processing of the bead base 116 of the second bead 112.

According to an embodiment, for processing the bead base 116 of the second bead 112, the suction device 428 is brought into a second suction position 446. According to an embodiment, in the second suction position 446, the beam path of the laser radiation 430 extends during a processing of the bead base 116 of the second bead 112 through the suction device 428, for example as illustrated in FIG. 19.

It should be noted that a tire processing machine as described herein is not limited to the specific entities as described in some embodiments and with reference to particular figures. Rather, the herein disclosed subject matter may be implemented in numerous ways in various granularities while still providing the specific functionality disclosed.

According to embodiments of the herein disclosed subject matter, any suitable entity (e.g. components, units and devices) or the functionality thereof may be provided at least partly in the form of corresponding computer programs or computer program products which enable a processor device to provide the functionality of the corresponding entity as described herein. According to other embodiments, any suitable entity as described herein may be provided in hardware. According to other hybrid embodiments, some entities may be provided in software while other entities are provided in hardware.

It is pointed out that any entity (e.g. components, units and devices) disclosed herein is not limited to a specific entity as described in some embodiments. Rather, the subject matter described herein may be provided in various ways with various granularity at device level or at software module level while still providing the specified functionality. Furthermore, it should be noted that according to embodiments a separate entity (e.g. a software module, a hardware module or a hybrid module) may be provided for each of the functions disclosed herein. According to other embodiments, an entity (e.g. a software module, a hardware module or a hybrid module) may be configured to provide two or more functions as described herein. According to still other embodiments, two or more entities (e.g. components, units and devices) may be configured to together provide a function as described herein.

According to an embodiment, the control device includes a processor device comprising at least one processor for executing at least one program element which may correspond to a corresponding software module.

A reference to a laser radiation may, of course, also be defined analogously with reference to a radiation path of the laser radiation, and vice versa. In this regard, any reference to a laser radiation discloses analogously a reference to a radiation path of the laser radiation.

It should be noted that the exemplary implementations described herein merely represent a limited selection of possible combinations of embodiments of the present disclosure. Thus, it is possible to combine the features of different embodiments with one another in a suitable manner, so that for a person skilled in the art with the exemplary implementations explicitly disclosed herein, a plurality of combinations of different embodiments are to be regarded as disclosed. Furthermore, it should be mentioned that terms such as “a” or “an” do not exclude a plurality. Terms such as “comprising” or “having” do not exclude further features or method steps. Thus, according to an embodiment, the term “comprising” or “having” stands for “comprising, among other things”. According to a further embodiment, the term “comprising” or “having” stands for “consisting of”. According to an embodiment, the term “adapted for” encompasses, among other things, the meaning “configured to”.

It should also be noted that reference numerals in the claims should not be interpreted as limiting the scope of the claims. Furthermore, it should be noted that reference numerals in the description and the reference of the description to the drawings should not be interpreted as limiting the scope of the description. Rather, the drawings illustrate only one exemplary implementation of a particular combination of several embodiments of the herein disclosed subject matter, wherein any other combination of embodiments is equally possible and is to be regarded as disclosed with this application.

In an exemplary implementation encompassing an advantageous combination of embodiments disclosed herein, it may be stated that:

Disclosed is a pneumatic tire having a bead having a bead base facing the rotational axis of the pneumatic tire; wherein the bead base has a protrusion extending toward the rotational axis and in a circumferential direction of the bead base; and wherein the protrusion has a geometry varying in the circumferential direction. Further disclosed is a pneumatic tire having a bead having a bead base facing a rotational axis of the pneumatic tire; wherein the bead base comprises a surface structure generated by removal of tire material along processing tracks in a processing region of the bead base; and wherein the surface structure is undulated. Further disclosed is a method and a tire processing machine for manufacturing the pneumatic tire. Further disclosed is a method for operating a tire processing machine, a wheel comprising the pneumatic tire, and a control device for controlling a method and a computer program product for controlling the method.

1-68. (canceled)

69. A pneumatic tire comprising:
a bead having a bead base facing the rotational axis of the pneumatic tire;
wherein the bead base comprises a protrusion extending toward the rotational axis and in a circumferential direction of the bead base; and
wherein the protrusion has a geometry varying in the circumferential direction.

70. The pneumatic tire according to claim 69, further comprising one or more of the following:
the varying geometry of the protrusion extends over an angular range that is smaller than 360 degrees;
the varying geometry of the protrusion extends over an angular range that is smaller than 180 degrees;
the angular range is in an interval between 20 degrees and 350 degrees;
the angular range is in an interval between 40 degrees and 160 degrees;
the protrusion is a first protrusion and the bead base comprises a second protrusion extending in the circumferential direction of the bead base;
the first protrusion and the second protrusion define between them a recess;
in an axial direction the recess is at least partially trough-shaped;
in the circumferential direction the recess is at least partially trough-shaped;
the recess in an axial direction is formed unsymmetrically;
the protrusion protrudes over a bottom of the bead base;
the geometry varying in the circumferential direction comprises a height of the protrusion varying in the circumferential direction with respect to the bottom;
a difference of a height of the protrusion at an angular position in the circumferential direction to a height of the protrusion at another angular position with respect to the bottom is at most 1 mm;
a difference of a height of the protrusion at an angular position in the circumferential direction to a height of the protrusion at another angular position with respect to the bottom is at most 0.5 mm;
the protrusion is arranged in an axial boundary area of the bead base.

71. The pneumatic tire according to claim 69, further comprising one or more of the following:
wherein the protrusion was generated by removal of tire material in a processing region of the bead base;
the removal of tire material was performed with laser radiation;
the laser radiation was a laser radiation of a CO2 laser;
the laser radiation was a continuous laser radiation;
the laser radiation had a Gaussian beam profile;
the laser radiation had a power of more than 400 W;
the laser radiation had a power of more than 800 W;
the removal of tire material was performed along at least one line;
the removal of tire material was performed along a plurality of parallel lines;
the parallel lines enclose with an axial direction an angle in a range between 0 degrees and 60 degrees or the parallel lines extend in the circumferential direction;
removal regions of neighboring lines overlap;
an overlap of removal regions of neighboring lines is between 10% and 90%;
an overlap of removal regions of neighboring lines is between 65% and 85%;
an overlap of removal regions of neighboring lines is 10%, 20%, 33.333%, 50%, 66.667%, 80%, or 90%;
the overlap of removal regions of neighboring lines is constant;
the overlap of removal regions of neighboring lines is dependent on a depth of the removal;
a depth of the removal varies continuously in the circumferential direction;
a variation of a depth of the removal in at least one of the circumferential direction and in the axial direction has been achieved at least partially by a variation of a power of the laser radiation;
a variation of a depth of the removal in at least one of the circumferential direction and in the axial direction has been achieved at least partially by a variation of a traverse speed of a laser spot over a surface of the bead base, wherein the laser radiation generates the laser spot on the surface of the bead base;
the bead in the processing region has a surface structure;
wherein the surface structure was generated by removal of tire material along processing tracks in the processing region;
wherein the surface structure is undulated;
the surface structure comprises at least one of a first structure portion and a second structure portion;
wherein the first structure portion comprises wave crests defined by an overlap of the processing tracks and wherein the overlap is between 10% and 90% of a width of the processing tracks;
the second structure portion comprises wave crests at a distance which is greater than a width of the processing tracks;
a distance between the wave crests of the first structure portion is greater than 0.05 mm;
a distance between the wave crests of the first structure portion is less than 2 mm;
the distance between the wave crests of the second structure portion is greater than 0.5 mm;
the distance between the wave crests of the second structure portion is less than 10 mm;
the wave crests of the first structure portion extend along the processing tracks;
a geometry of the wave crests of the second structure portion varies in a longitudinal direction of the wave crests;
an amplitude of the surface structure is between 0.005 mm and 0.25 mm;
an amplitude of the surface structure varies in a circumferential direction;
starting from a location of maximum amplitude, the amplitude of the surface structure in the circumferential direction decreases continuously;
the wave crests of the surface structure are arranged at least partially parallel to each other;
at least one boundary area of the bead base is free of the surface structure;
in the processing region a recess is formed in the bead base.

72. A method for processing a pneumatic tire, wherein the pneumatic tire comprises a bead base, wherein the pneumatic tire defines an axial direction parallel to the rotational axis of the pneumatic tire and wherein the pneumatic tire defines a circumferential direction around the rotational axis, the method comprising:
removing of tire material in a processing region of the bead base and thereby generating a protrusion extending toward the rotational axis and in the circumferential direction and wherein the protrusion has a geometry varying in the circumferential direction.

73. The method according to claim 72, further comprising one or more of the following:
the protrusion extends over an angular range that is smaller than 360 degrees;
the pneumatic tire during the removing of tire material is rotated about its rotational axis;
in at least a part of the processing region tire material is removed multiple times;
the protrusion is a first protrusion and the removing of tire material in the processing region generates a second protrusion extending in the circumferential direction;
the processing region is arranged between the first protrusion and the second protrusion and thereby defines a recess between the first protrusion and the second protrusion;
the recess in at least one of the axial direction and the circumferential direction is trough-shaped;
the removing of tire material is performed up to a depth and the depth varies in the circumferential direction of the protrusion;
the processing region comprises a central region of the bead base and the central region of the bead base is arranged in the axial direction between boundary areas of the bead base.

74. The method according to claim 72, further comprising one or more of the following:
the removing of tire material is performed with laser radiation;
the laser radiation is a laser radiation of a CO2 laser;
the CO2 laser is operated continuously during the removing;
the CO2 laser has a Gaussian beam profile;
the CO2 laser has an output power of more than 400 W;
the CO2 laser has an output power of more than 800 W;
the removing of the tire material is performed along at least one line;
the removing of the tire material is performed along a plurality of parallel lines;
the parallel lines enclose with the axial direction an angle in a range between 0 degrees and 60 degrees or the parallel lines extend in the circumferential direction;
removal regions of neighboring lines overlap;
an overlap of removal regions of neighboring lines is between 10% and 90%;
an overlap of removal regions of neighboring lines is between 65% and 85%;
an overlap of removal regions of neighboring lines is 10%, 20%, 33.333%, 50%,

66. 667%, 80%, or 90%;
the overlap of removal regions of neighboring lines is constant;
the overlap of removal regions of neighboring lines is dependent on a depth of a removal generated by the removing;
during the removing of tire material in the processing region a power of the laser radiation is varied dependent on at least one of a position in the axial direction and a position in the circumferential direction;
during the removing of the tire material a rotation of the pneumatic tire about the rotational axis is performed;
during the removing of the tire material a rotation of the pneumatic tire about the rotational axis at a constant angular speed is performed;
the rotation of the pneumatic tire about the rotational axis is compensated for in a positioning of the laser radiation in the processing region.

75. The method according to claim 72, further comprising one or more of the following:
at least one first holding finger is engaged with a first bead of the pneumatic tire and at least one second holding finger is engaged with a second bead of the pneumatic tire;
a distance between the first bead and the second bead is adjusted by a positioning of the at least one first holding finger and the at least one second holding finger relative to each other;
the rotating of the pneumatic tire during the removing of the tire material is performed by a driving of the at least one first holding finger into a rotational movement;
during the driving of the at least one first holding finger into a rotational movement, the second bead is in rolling engagement with the at least one second holding finger and the removing is performed on the second bead;
after the removing of tire material from the second bead, the removing of tire material from the first bead is performed;
a rotating of the pneumatic tire during the removing from the first bead is performed by a driving of the at least one second holding finger into a rotational movement;
the at least one second holding finger during the driving into a rotational movement is in frictional engagement with the pneumatic tire;
the at least one second holding finger during the driving into a rotational movement is in frictional engagement with the pneumatic tire by a blocking of at least one roller of the at least one second holding finger;
the at least one second holding finger during the driving into a rotational movement is in frictional engagement with the pneumatic tire by a blocking of at least one roller of the at least one second holding finger;
during the driving of the at least one second holding finger into a rotational movement the first bead is in rolling engagement with the at least one first holding finger;
the at least one first holding finger is engaged with the first bead of the pneumatic tire by moving the at least one first holding finger in a first transverse direction into the pneumatic tire and subsequently moving the at least one first holding finger in a direction towards the first bead;
the at least one second holding finger is engaged with the second bead of the pneumatic tire by moving the at least one second holding finger in a second transverse direction into the pneumatic tire and subsequently moving the at least one second holding finger in a direction towards the second bead;
the at least one first holding finger is mounted at a carrier;
the at least one first holding finger is moved in the first transverse direction into the pneumatic tire by lifting the carrier, wherein the carrier is arranged below a transport device;
for a driving of the at least one first holding finger into a rotational movement the carrier is lifted over the transport device and subsequently the carrier is driven into the rotational movement.

76. A tire processing machine for processing a pneumatic tire, wherein the pneumatic tire to be processed comprises a first bead and a second bead, wherein the pneumatic tire defines an axial direction parallel to a rotational axis of the pneumatic tire and wherein the pneumatic tire defines a circumferential direction around the rotational axis, the tire processing machine comprising:
at least one first holding finger which is engageable with the first bead;
at least one second holding finger which is engageable with the second bead;
wherein the at least one first holding finger is operable to rotate the pneumatic tire with respect to the at least one second holding finger.

77. The tire processing machine according to claim 76, further comprising one or more of the following:
the at least one first holding finger is operable to rotate the pneumatic tire, together with the at least one first holding finger, with respect to the at least one second holding finger;
the at least one second holding finger is operable to rotate the pneumatic tire together with the at least one second holding finger with respect to the at least one first holding finger;
the at least one first holding finger is configured to hold the first bead and the second bead at a predetermined distance;
the at least one second holding finger is configured to hold the first bead and the second bead at a predetermined distance;
the at least one first holding finger is configured for insertion of the at least one first holding finger into the pneumatic tire from a first side of the pneumatic tire;
the at least one second holding finger is configured for insertion of the at least one second holding finger into the pneumatic tire from a second side of the pneumatic tire, wherein the second side of the pneumatic tire is arranged opposite to the first side of the pneumatic tire.

78. The tire processing machine according to claim 76, further comprising one or more of the following:
a suction device;
the suction device is bringable into a first position for suctioning process residues of a processing of the first bead;
the suction device is bringable into a second position for suctioning process residues of a processing of the second bead;
the tire processing machine comprises at least two of the first holding fingers and the suction device is positionable between two neighboring first holding fingers;
the tire processing machine comprises at least two of the second holding fingers and the suction device is positionable between two neighboring second holding fingers;
a spatial position of the holding fingers, between which the suction device is positioned, remains unchanged during the processing.

79. The tire processing machine according to claim 76, further comprising one or more of the following:
a laser emitting device for emitting laser radiation onto the pneumatic tire for thereby processing the pneumatic tire;
the laser emitting device is arranged radially outside the pneumatic tire;
the laser emitting device comprises at least one scanner for moving a beam path of the laser radiation over the pneumatic tire;
a scanning movement of the beam path comprises a directional component parallel to the axis of rotation;
wherein the laser emitting device is configurable for processing a bead base of the first bead;
wherein the laser emitting device is configurable for processing a bead base of the second bead;
wherein the laser emitting device is configurable for processing an inner surface of the pneumatic tire;
a transport device on which the pneumatic tire is transportable in a lying manner;
the at least one first holding finger and the at least one second holding finger are engageable with the pneumatic tire lying on the transport device;
the pneumatic tire is liftable by the at least one first holding finger from the transport device to a lifted position such that a sidewall of the pneumatic tire faces the transport device at a distance;
the pneumatic tire is liftable by the at least one second holding finger from the transport device to a lifted position such that a sidewall of the pneumatic tire faces the transport device at a distance;
the laser emitting device is configured for processing the pneumatic tire in the lifted position.

80. The tire processing machine according to claim 76, further comprising one or more of the following:
the at least one first holding finger comprises a mechanical stop for a first surface portion of the first bead;
the at least one second holding finger comprise a mechanical stop for a second surface portion of the second bead;
at least one of the at least one first holding finger comprises at least one first roller on which the first surface portion is rollable;
at least one of the at least one second holding finger comprises at least one second roller on which the second surface portion is rollable;
on at least one of the at least one first roller, a lateral bead part of the first bead is rollable;
on at least one of the at least one first roller, a bead base of the first bead is rollable;
on at least one of the at least one second roller, a lateral bead part of the second bead is rollable;
on at least one of the at least one second roller, a bead base of the second bead is rollable;
at least one of the at least one first roller is blockable in its rotation for a frictional engagement of the pneumatic tire and the first roller;
at least one of the at least one second roller is blockable in its rotation for a frictional engagement of the pneumatic tire and the second roller;
at least one of the at least one first roller is drivable into a rotation for driving the pneumatic tire into a rotational movement;
at least one of the at least one second roller is drivable into a rotation for driving the pneumatic tire into a rotational movement;
the at least one first holding finger at a distance from the rotational axis is rotatable by at least 360 degrees about the rotational axis;
the at least one second holding finger at a distance from the rotational axis is rotatable by at least 360 degrees about the rotational axis.

81. A method according to claim 72, the method further comprising operating a tire processing machine for processing the pneumatic tire, the method comprising:
engaging at least one first holding finger with the first bead;
engaging at least one second holding finger with the second bead;
operating the at least one first holding finger to rotate the pneumatic tire with respect to the at least one second holding finger.

82. A pneumatic tire according to claim 69, the pneumatic tire forming part of a wheel comprising a rim and the pneumatic tire mounted on the rim.

83. The wheel according to claim 82, further comprising one or more of the following:
the protrusion of the bead base is deformed by the rim;
due to the rim the protrusion of the bead base comprises a circumferentially varying deformation.
